(19) United States
(12) Patent Application Publication
(10) Pub. No.: US 2008/0016311 A1
(43) Pub. Date: Jan. 17, 2008

(54) SAN/NAS integrated management computer and method

(76) Inventor: Akitatsu Harada, Tama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/510,697

(22) Filed: Aug. 28, 2006

(30) Foreign Application Priority Data
Jul. 12, 2006 (JP) 2006-192131

(51) Int. Cl. G06F 12/00

(52) U.S. Cl. 711/170

(57) ABSTRACT

A computer, which manages a SAN/NAS system, comprises a configuration information acquisition part, and a configuration association part. The configuration information acquisition part respectively acquires NAS host configuration information managed by a NAS host, and storage configuration information managed by a storage system. The configuration association part retrieves from storage configuration information a second information element, which conforms to a first information element in SAN host configuration information, and associates the retrieved second information element to the first information element.

### CROSS-REFERENCE TO PRIOR APPLICATION

This application relates to and claims priority from Japanese Patent Application No. 2006-192131, filed on Jul. 12, 2006 the entire disclosure of which is incorporated herein by reference.

### BACKGROUND OF THE INVENTIONS

1. Field of the Invention

The present invention relates to technology for managing a computer system.

2. Description of the Related Art

For example, the technologies disclosed in Literature No. 1 (Japanese Patent Laid-open No. 2005-115581), Literature No. 2 (Japanese Patent Laid-open No. 2003-345631) and Literature No. 3 (Japanese Patent Laid-open No. 2004-164558) are known. In Literature No. 1, technology for allocating a logical volume and path is disclosed. In Literature No. 2, technology, which selects whether to allocate a file system area or a SAN storage logical device to a host based on the storage configuration and file system area requirements, is disclosed. In Literature No. 3, technology for recognizing a SAN topology is disclosed.

### SUMMARY OF THE INVENTION

Now then, a SAN (Storage Area Network) environment computer system (hereinafter, SAN system) and a NAS (Network Attached Storage) environment computer system (hereinafter, NAS system) are each known. In a SAN system, for example, a storage subsystem comprising a plurality of storage devices, and a plurality of host computers (hereinafter, FC hosts), which utilize data inside the storage devices in the storage subsystem, are connected to a fibre channel network (hereinafter, FC network). In a NAS system, for example, a computer (hereinafter, NAS client), which uses a NAS host, and a NAS head (hereinafter, NAS host), which receives a file level I/O command from the NAS client, and accesses a storage device in accordance with that I/O command, are connected to a communication network (hereinafter, IP network) in which communications are carried out in accordance with IP (Internet Protocol). The storage device, which constitutes the access destination of the NAS host, is in a storage subsystem.

As types of NAS hosts, there is the remote server machine, which is connected to the storage subsystem, and the server machine built into the storage subsystem (for example, the so-called blade server). The former can be called a generic NAS, and abbreviated as “G-NAS”. Conversely, the latter can be called embedded NAS, and abbreviated as “E-NAS”.

A SAN system and a NAS system are each independent computer systems, but a computer system, which integrates these computer systems, can be built (hereinafter, SAN/NAS system). A SAN/NAS system can be constructed by incorporating a device belonging to a NAS system (NAS device) into at least one of the plurality of devices of a SAN system (SAN devices). More specifically, for example, as illustrated in FIG. 1, a SAN/NAS system can be constructed by either making an FC host of a SAN system into a NAS client by connecting it to a G-NAS, or by connecting a G-NAS to a storage subsystem connected to a SAN.

However, constructing a SAN/NAS system such as this increases the burden of management for the administrator. This is because management is carried out independently for the SAN system and NAS system.

More specifically, in the past, the management of information related to a NAS system was not considered in the management of a SAN system. More specifically, as information, which is managed in a SAN system, for example, there is the block level capacity of a logical volume (LU) and the port identifier of an access destination, but the file level capacity and data of an LU are not managed.

Conversely, in the management of a NAS system, because the NAS head is positioned the same as a file server on an IP network, file level management has been carried out for some time now, and is commonly managed as a single device on the IP network. For this reason, similar to the FC hosts, the management of the part, which maps the LU to the NAS from the storage system and adds the capacity, is entrusted to SAN system management. Further, a NAS client generally falls outside the scope of management in the managing of a NAS system.

As described hereinabove, in the past management was carried out independently for a SAN system and NAS system, respectively. Thus, even if a SAN/NAS system is constructed, an element in the SAN environment and an element in the NAS environment will be managed independently, and for the administrator, the management burden will become great, making it impossible for him to carry out the overall management of the SAN/NAS system (for example, he will not be able to grasp the configuration of the SAN/NAS system).

Therefore, an object of the present invention is to enable the SAN environment and NAS environment in a SAN/NAS system to be managed in an integrated condition.

Other objects of the present invention should become clear from the following explanation.

A management computer according to the present invention is a computer for managing a computer system comprising one or more SAN devices and one or more NAS devices. This management computer can be a computer in which a SAN device and a NAS device exist separately, and a management computer according to the present invention can also be realized by either mounting the plurality of parts of this management computer to either the SAN device or the NAS device, or mounting these parts by distributing them among these devices.

A SAN device is a device, which is connected to a storage area network (SAN), and which has a SAN storage resource, which stores SAN configuration information related to elements thereof.

A NAS device is a device, which is connected to an IP network, and which has a NAS storage resource, which stores NAS configuration information related to elements thereof.

The above-mentioned one or more SAN devices comprise, at least a storage system from among a storage system, which comprises a plurality of storage devices, and a SAN host, which is a host computer for accessing a storage device inside the above-mentioned storage system.

The above-mentioned storage system comprises the above-mentioned SAN storage resource, which stores storage configuration information as the above-mentioned SAN configuration information, and a controller part having a plurality of communication ports.

The above-mentioned SAN host comprises the above-mentioned SAN storage resource, which stores SAN host configuration information as the above-mentioned SAN configuration information.

The above-mentioned one or more NAS devices comprise a NAS host, which is the NAS head for accessing a storage device inside the above-mentioned storage system.

The above-mentioned NAS host comprises the above-mentioned NAS storage resource, which stores NAS host configuration information as the above-mentioned NAS configuration information.

The above-mentioned controller part of the above-mentioned storage system accesses any of the above-mentioned plurality of storage devices based on the above-mentioned storage configuration information in accordance with an I/O command received by way of any of the above-mentioned plurality of communication ports from either the above-mentioned NAS host or the above-mentioned SAN host.

The above-mentioned management computer comprises a configuration information acquisition part for acquiring both the above-mentioned SAN configuration information and the above-mentioned NAS configuration information; and a configuration association part for retrieving from the above-mentioned NAS configuration information a second information element, which corresponds to a first information element in the above-mentioned SAN configuration information, and associating the retrieved above-mentioned second information element to the above-mentioned first information element.

In a first embodiment, the above-mentioned NAS host is a generic NAS (G-NAS), which is a remote NAS head connected to the above-mentioned storage system by way of the above-mentioned SAN. As an information element included in the above-mentioned NAS host configuration information, there is at least one of a logical unit number (LUN) mapped to the above-mentioned G-NAS, a G-NAS port ID, which is the port ID of a communication port of the above-mentioned G-NAS, and the port ID of the allocation destination of this communication port. The above-mentioned storage configuration information comprises path information. The above-mentioned path information is information expressing each path in the above-mentioned storage system. As the information elements included in the above-mentioned path information, there is a storage port ID, which is a port ID of the communication port of the above-mentioned controller part, a port ID of the allocation source of this communication port, and a LUN to which the above-mentioned storage device is associated, from which each path is constituted. The above-mentioned first information element is at least one of the above-mentioned storage port ID, the above-mentioned allocation source port ID, and the LUN. The above-mentioned second information element is at least one of the above-mentioned G-NAS port ID, the above-mentioned allocation destination port ID, and the LUN. In other words, the above-mentioned configuration association part can associate reciprocal configuration information when at least one of the following cases exists: when the storage ID and the allocation destination port ID correspond to one another; when the allocation source port ID and the G-NAS port ID correspond to one another; or when the respective LUN correspond to one another.

In a second embodiment, the above-mentioned configuration association part in the above-mentioned first embodiment carries out association when the above-mentioned storage port ID corresponds to the above-mentioned allocation destination port ID, and the above-mentioned allocation source port ID corresponds to the above-mentioned G-NAS port ID.

In a third embodiment, the above-mentioned NAS host is an embedded NAS (E-NAS), which is a NAS head that is built into the above-mentioned storage system. It has a storage resource, which stores NAS host configuration information as the above-mentioned NAS configuration information. As an information element included in the above-mentioned NAS host configuration information, there is at least one of a first type E-NAS identifier, a logical unit number (LUN) mapped to the above-mentioned E-NAS, and a second type E-NAS identifier. The above-mentioned E-NAS is in the above-mentioned controller part. The above-mentioned storage configuration information comprises, from among a management identifier for identifying an E-NAS, which is utilized when managing the above-mentioned E-NAS, and path information, at least the path information. The above-mentioned path information is information for expressing each path in the above-mentioned storage system. As the information elements in the above-mentioned path information, there is a port ID of a communication port, and a LUN to which is associated the above-mentioned storage device, from which each path is constituted, and in each port ID, there is an E-NAS identifier as the port ID. The above-mentioned first information element is at least one of the above-mentioned management identifier, the above-mentioned E-NAS identifier treated as a port ID, and the above-mentioned LUN. The above-mentioned second information element is at least one of the above-mentioned first type of E-NAS identifier, the above-mentioned second type of E-NAS identifier, and the above-mentioned LUN. In other words, the above-mentioned configuration association part can associate reciprocal configuration information when at least one of the following cases exists: when the management identifier and the first type E-NAS identifier (for example, an IP address and a DNS (Domain Name System) host name, respectively) correspond to one another; when an E-NAS identifier treated as a port ID and the above-mentioned second type E-NAS identifier correspond to one another (for example, numbers); or when the respective LUN correspond to one another.

In a fourth embodiment, the management computer further comprises a topology computation part, which computes the topology of a plurality of elements in the above-mentioned computer system by analyzing the above-mentioned NAS host configuration information and the above-mentioned storage configuration information, which are mutually associated; and a display control part for displaying the above-mentioned computed topology. The above-mentioned topology comprises the connection relationship of a plurality of elements comprising an element in the above-mentioned NAS host, and a storage device inside the above-mentioned storage system. The above-mentioned display control part plots each element object, which is an object for displaying each element constituting the above-mentioned computed topology, and each element connection object, which is an object for displaying the connections between each element.

In a fifth embodiment, the above-mentioned management computer in the above-mentioned fourth embodiment further comprises an association computation part, which treats a designated element of a plurality of elements constituting the above-mentioned displayed topology as a reference point, and computes an element associated to this designated element. The above-mentioned display control part makes the display mode of the object of the computed element differ from the display mode of an object of another element constituting the above-mentioned topology.

In a sixth embodiment, the above-mentioned association computation part in the above-mentioned fifth embodiment makes the above-mentioned designated element a reference point, and computes an element, which has an impact on the above-mentioned designated element. In this computation, for example, it is possible to determine, from a first convention, whether or not an element will impact on the above-mentioned designated element.

In a seventh embodiment, the above-mentioned association computation part of the above-mentioned fifth embodiment treats the above-mentioned designated element as a reference point, and computes an element, which will be impacted by the above-mentioned designated element. In this computation, for example, it is possible to determine, from a second convention, whether or not an element will be impacted by the above-mentioned designated element.

In an eighth embodiment, the above-mentioned association computation part of the above-mentioned fifth embodiment, based on a prescribed convention, allocates a degree of association for displaying the depth of relevance between a computed element and the above-mentioned designated element. The above-mentioned display control part makes the display mode for the object of the above-mentioned computed element a display mode that corresponds to the allocated degree of association.

In a ninth embodiment, the above-mentioned management computer of the above-mentioned fourth embodiment further comprises an association computation part, which receives a designation of a certain data element of a plurality of elements constituting the above-mentioned displayed topology, treats the designated data element as a reference point, and computes a data path comprising this designated data element. The above-mentioned display control part makes the display mode of the object related to the computed data path differ from the display mode of another object constituting the above-mentioned topology. The above-mentioned data element is an element related to data exchanged between at least one of the above-mentioned SAN host and the above-mentioned NAS host, and a storage device inside the above-mentioned storage system, and is at least one of a storage device and a communication port.

In a tenth embodiment, the above-mentioned display control part of the above-mentioned fifth embodiment displays the above-mentioned computed topology as a graphical user interface (GUI), and receives an element designation from a user by way of the respective plotted objects. The above-mentioned association computation part treats an element corresponding to an object designated from a user on the above-mentioned GUI as a reference point, and computes an element, which is related to this designated element.

In an eleventh embodiment, the above-mentioned NAS device has a NAS client, which transmits an I/O command to the above-mentioned NAS host. The above-mentioned NAS client has a storage resource for storing NAS client configuration information as the above-mentioned NAS configuration information. As an information element included in the above-mentioned NAS client configuration information, there is at least one of an IP address allocated to a communication port of the above-mentioned NAS client, and an ID of a share area utilized by the above-mentioned NAS client. As an information element included in the above-mentioned NAS host configuration information, there is at least one of an IP address allocated to a communication port of the above-mentioned NAS client, and an ID of a share area utilized by the above-mentioned NAS host. The configuration association part retrieves from the NAS host configuration information a fourth information element conforming to a third information element in the NAS client configuration information, and associates the third information element in the NAS client configuration information to the retrieved fourth information element. The third and fourth information elements are at least one of a share area ID and an IP address.

In a twelfth embodiment, in the above-mentioned storage configuration information, an attribute for either a SAN element or a NAS element is made correspondent to a prescribed type of element of a plurality of elements managed by the above-mentioned storage configuration information. The above-mentioned management computer comprises a configuration correctness determination part for determining the existence of an incorrect association by analyzing the above-mentioned NAS host configuration information and the above-mentioned storage configuration information, which are associate to one another, in accordance with the association of the above-mentioned first and second information elements, and a display control part for displaying the determination result by the above-mentioned configuration correctness determination part. The above-mentioned incorrect association is one in which the above-mentioned NAS host is associated to the above-mentioned SAN element.

In a thirteenth embodiment, the determination result displayed by the above-mentioned display control part in the above-mentioned twelfth embodiment is a GUI. The above-mentioned management computer further comprises a configuration modification part. The above-mentioned configuration modification part receives from a user via the above-mentioned GUI a command to cancel an incorrect association, and upon receiving this command, transmits to the device, of the above-mentioned SAN device and the above-mentioned NAS device, which has the configuration information for managing the element related to the above-mentioned incorrect association, a command instructing the cancellation of an element related to the above-mentioned incorrect association.

In a fourteenth embodiment, the above mentioned storage system comprises a plurality of virtual storage systems. In the above-mentioned storage configuration information, the respective elements existing in the above-mentioned storage system are allocated to the respective virtual storage system IDs. The above-mentioned management computer further comprises a topology computation part, which computes the topology of the plurality of elements in the above-mentioned computer system by analyzing the above-mentioned SAN configuration information, and the above-mentioned NAS configuration information, which are mutually associated, and a display control part, which displays the above-mentioned computed topology. The above-mentioned display control part plots the respective element objects, which are objects for displaying the respective elements constituting the above-mentioned computed topology, and the respective element connection objects, which are objects for displaying the connections between the respective elements. The above-mentioned element objects include the above-mentioned virtual storage system.

In a fifteenth embodiment, the above-mentioned displayed topology in the above-mentioned fourteenth embodiment is a GUI. The above-mentioned management computer further comprises a first association computation part, which, of a plurality of elements constituting the above-mentioned displayed topology, treats a virtual storage system designated via the above-mentioned GUI as a reference point, and computes an element which will be impacted by this designated virtual storage system, a second association computation part, which, of the one or more elements computed by the above-mentioned first association computation part, treats the designated either the above-mentioned SAN host or the above-mentioned NAS host, as a reference point, and computes an element, which will impact the above-mentioned designated either SAN host or NAS host, and a third association computation part, which, of the one or more elements computed by the above-mentioned second association computation part, treats a designated data element as a reference point, and computes a data path comprising this designated data element. The above-mentioned display control part makes the display mode of the object related to the computed data path differ from the display mode of the other objects constituting the above-mentioned topology. The above-mentioned data element is an element related to data exchanged between at least one of the above-mentioned SAN host and the above-mentioned NAS host, and a storage device inside the above-mentioned storage system, and is at least one of either a storage device or a communication port.

In a sixteenth embodiment, the above-mentioned management computer in the above-mentioned fifteenth embodiment further comprises a configuration modification part. The above-mentioned configuration modification part receives from the above-mentioned user via the above-mentioned GUI a command to cancel a data path designated by the above-mentioned user, and upon receiving this command, transmits to the device, of the above-mentioned SAN device and the above-mentioned NAS device, which has configuration information for managing the element related to the above-mentioned designated data path, a command instructing the cancellation of an element related to the above-mentioned designated data path.

In a seventeenth embodiment, the above-mentioned configuration association part retrieves from the above-mentioned storage configuration information a sixth information element corresponding to a fifth information element in the above-mentioned SAN host configuration information, and associates the retrieved above-mentioned sixth information element to the above-mentioned fifth information element. The above-mentioned management computer further comprises a topology computation part, which computes the topology of the plurality of elements in the above-mentioned computer system by analyzing the above-mentioned SAN host configuration information, the above-mentioned NAS host configuration information, and the above-mentioned storage configuration information, which are mutually associated, a display control part, which displays the above-mentioned computed topology GUI, a first association computation part, which, of the plurality of elements constituting the above-mentioned displayed topology, treats an element designated via the above-mentioned GUI as a reference point, and computes an element, which impacts the above-mentioned designated element, and a second association computation part, which, of the plurality of elements constituting the above-mentioned displayed topology, treats an element designated via the above-mentioned GUI as a reference point, and computes an element, which will be impacted by the above-mentioned designated element. The above-mentioned topology comprises a first connection relationship of a plurality of elements comprising an element in the above-mentioned SAN host and a storage device inside the above-mentioned storage system, and a second connection relationship of a plurality of elements comprising an element in the above-mentioned NAS host and a storage device inside the above-mentioned storage system. The above-mentioned display control part plots the respective element objects, which are objects for displaying the respective elements constituting the above-mentioned computed topology, and the respective element connection objects, which are objects for displaying the connections between the respective elements, and makes the display mode of the objects of the elements computed by the above-mentioned first and second association computation parts differ from the display mode of the objects of the other elements constituting the above-mentioned topology.

In the above-mentioned embodiments, for example, each type of computation part can write the results of a computation to a storage resource (for example, a memory) inside the management computer, and the display control part can execute a display based on the computation results, which have been -written to this storage resource.

Each part of the management computer can also be referred to as means. Each part or means can be achieved via hardware (for example., a circuit), a computer program, or a combination of these (for example, by either one or a plurality of CPUs, which read in and execute a computer program.). Each computer program can be read in from a storage resource (for example, a memory), which is in a computer machine. A computer program can be installed in this storage resource via a CD-ROM, DVD (Digital Versatile Disk) or other such recording medium, and it can also be downloaded by way of the Internet, a LAN or other such communication network.

### BRIEF DESCRIPTION OF THE DRAWINGS

FIG. 1 shows an example of the configuration of a SAN/NAS system;

FIG. 2 shows an example of the configuration of a SAN/NAS system related to an embodiment of the present invention, and an overview of this embodiment;

FIG. 3 shows an example of the configuration of a SAN/NAS integrated management server 139;

FIG. 4 shows a concept of configuration information, which is managed by a storage subsystem 100;

FIG. 5 shows an example of a CHN cluster;

FIG. 6 shows an example of the configuration of a path determination management table 231;

FIG. 7 shows an example of the configuration of an LDEV management table 233;

FIG. 8 shows an example of the configuration of a disk management table 235;

FIG. 9 shows an example of the configuration of a CHN address management table 237;

FIG. 10 shows an example of the configuration of a mount point table 241;

FIG. 11 shows an example of the configuration of a user access management table 243;

FIG. 12 shows an example of the configuration of a share table 245;

FIG. 13 shows an example of the configuration of a LUN mapping table 251 in an E-NAS;

FIG. 14 shows an example of system information 253 in an E-NAS;

FIG. 15 shows an example of the configuration of a LUN mapping table 261 in a G-NAS;

FIG. 16 shows an example of system information 263 in a G-NAS;

FIG. 17 shows an example of SAN/NAS association processing performed by integrated management software 141;

FIG. 18 shows an example of the flow of processing carried out in S120 of FIG. 17;

FIG. 19 shows an example of the flow of processing carried out in S130 of FIG. 17;

FIG. 20 shows an example of a logical topology GUI;

FIG. 21 shows an example of a physical topology GUI;

FIG. 22 shows an example of a G-NAS dependency correlation;

FIG. 23 shows an example of an E-NAS dependency correlation;

FIG. 24 shows an example of the display of the results of a dependency computation of the E-NAS “eNAS CL1”;

FIG. 25 shows an example of the flow of processing of a dependency computation for calculating an element that is dependent on a specified NAS host;

FIG. 26 shows an example of a configuration of the display of the results of estimating the impact of a failure of the E-NAS “eNAS CL1”;

FIG. 27 shows an example of the flow of processing of a failure scope-of-impact estimation for a specified NAS host;

FIG. 28 shows an example of the display of the results of a dependency computation of the storage subsystem “Storage”;

FIG. 29 shows an example of the flow of processing of a dependency computation for computing an element that is dependent on a specified storage subsystem;

FIG. 30 shows an example of the display of the results of a failure scope-of-impact estimation for the storage subsystem “Storage”;

FIG. 31 shows an example of the flow of processing of a failure scope-of-impact estimation for a specified storage system;

FIG. 32 shows an example of the display of the results of a dependency computation for the FC host “FC host”;

FIG. 33 shows an example of the flow of processing of a dependency computation for computing an element that is dependent on a specified FC host;

FIG. 34 shows an example of the display of the results of a failure scope-of-impact estimation for the FC host “FC host”;

FIG. 35 shows an example of the flow of processing of a failure scope-of-impact estimation for an FC host;

FIG. 36 is a schematic diagram of a logical partition function;

FIG. 37 shows an example of the topologies of a storage subsystem and an external storage system;

FIG. 38 shows an example of a SAN/NAS system when a SAN logical partition and a NAS logical partition are set as partition attributes;

FIG. 39 shows an example of a logical topology GUI in a SAN/NAS system having logical partitions;

FIG. 40 shows an example of the GUI displayed when a failure scope-of-impact display is specified in the GUI of FIG. 39;

FIG. 41 shows an example of the GUI displayed when a dependence display is specified in the GUI of FIG. 40;

FIG. 42 shows an example of the GUI displayed when a confirm data path is specified in the GUI of FIG. 41;

FIG. 43 is a schematic diagram of an example of when data path cancellation is specified in the GUI of FIG. 42;

FIG. 44 shows another example of the GUI displayed when a confirm data path is specified in the GUI of FIG. 41;

FIG. 45 shows an example of a SAN/NAS system when a special host logical partition is set as a partition attribute; and

FIG. 46 shows an example of the GUI displayed when a dependence display is specified in the logical topology GUI of a SAN/NAS system comprising an FC host/NAS client.

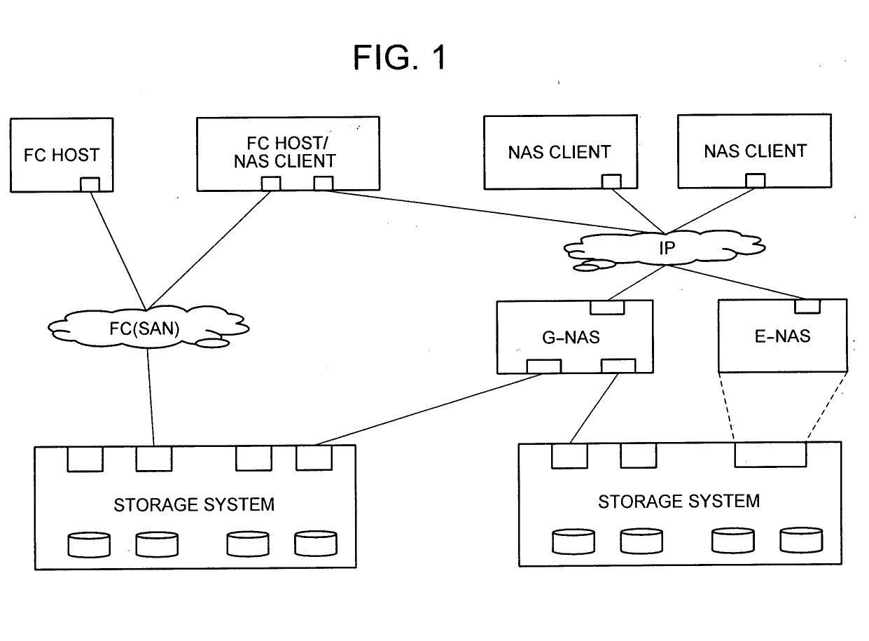

### DESCRIPTION OF THE PREFERRED EMBODIMENTS

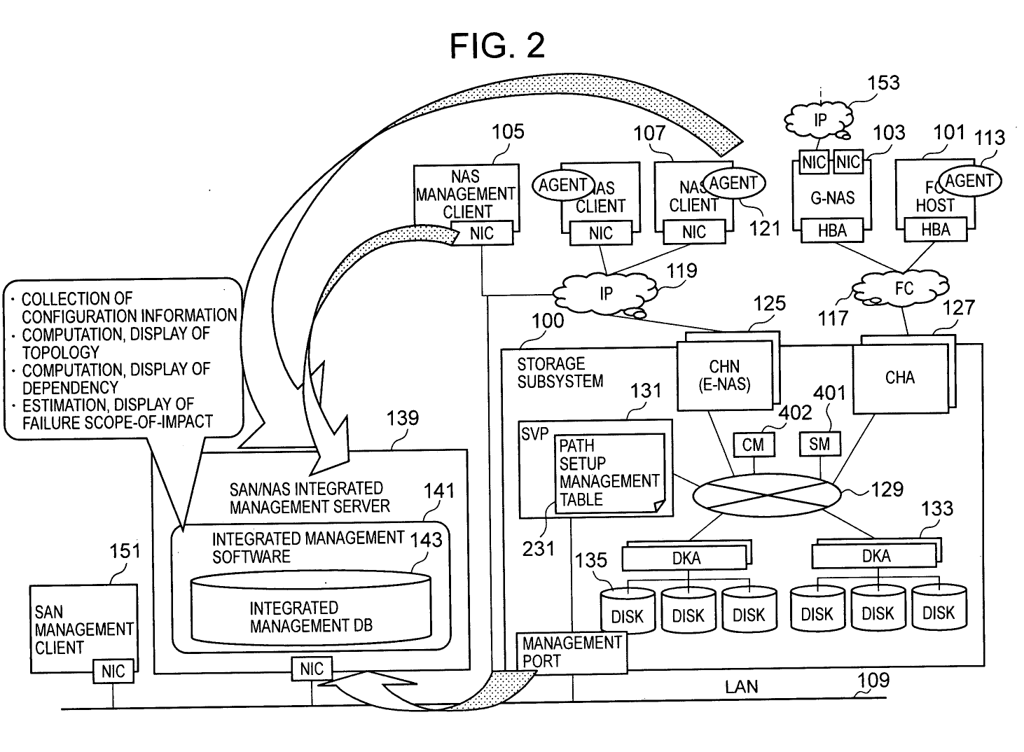

FIG. 2 shows an example of the configuration of a SAN/NAS system related to a first embodiment of the present invention, and an overview of this embodiment.

Either one or a plurality of NAS clients 107, a computer for managing a NAS environment (hereinafter, NAS management client) 105, and a channel adapter NAS (referred to hereinabove as E-NAS, and hereinafter as “E-NAS” or “CHN”) 125 are connected to an IP network 119. Further, a G-NAS 103 is connected to another IP network 153, for receiving an I/O command from a NAS client (not shown in the figure) via this network 153. The respective clients 107, 105, CHN 125 and G-NAS 103 comprise, for example, a NIC (Network Interface Card) as a communication I/F, and the NIC is connected to the IP networks 119, 153.

A G-NAS 103, FC host 101, and channel adapter (hereinafter, CHA) 127 are connected to a fibre channel network (hereinafter, FC network) 117. The G-NAS 103 and FC host 101 comprise, for example, an HBA (Host Bus Adapter) as a communication I/F, and a communication port (hereinafter, FC port) in the HBA is connected to the FC network 117. A storage subsystem 100, for example, comprises, in addition to CHN 125 and CHA 127, a plurality of disks (for example, hard disk drives) 135, a disk adapter (hereinafter, DKA) 133 for controlling input and output to and from the respective disks 135, a shared memory (SM) 401 for storing control information, which is referenced by the respective adapters 125, 127 and 133, and a cache memory (CM) 402 for temporarily storing data exchanged between the G-NAS 103 and FC host 101, and the disks 135. The SM 401 and CM 402 can be integrated. Further, the storage subsystem 100 comprises a processor for maintaining the storage subsystem 100 (hereinafter referred to as “SVP”, the abbreviation for service processor) 131, a connection part 129 to which the CHN 125, CHA 127, DKA 133, and SVP 131 are connected, and a communication port for connecting the SVP 131 to a LAN (Local Area Network) 109 (hereinafter, management port). The connection part 129, for example, is a switch (more specifically, a high speed crossbar switch), and connections between devices are switched via the connection part 129. The CHN 125 and CHA 127, for example, are computers (for example, circuit boards) comprising a CPU and a storage resource (for example, a memory) and so forth. The SVP 131, for example, can be constituted as a computer (for example, a notebook computer) having a CPU and storage resource (for example, a memory) and so forth.

The LAN 109 (This can also be another type of communication network.) is connected to the IP network 119. Connected to the LAN 109 are, in addition to the storage subsystem 100, a computer for managing a SAN environment (hereinafter, SAN management client) 151, and a computer for uniformly managing a SAN environment and NAS environment (hereinafter, SAN/NAS integrated management server) 139.

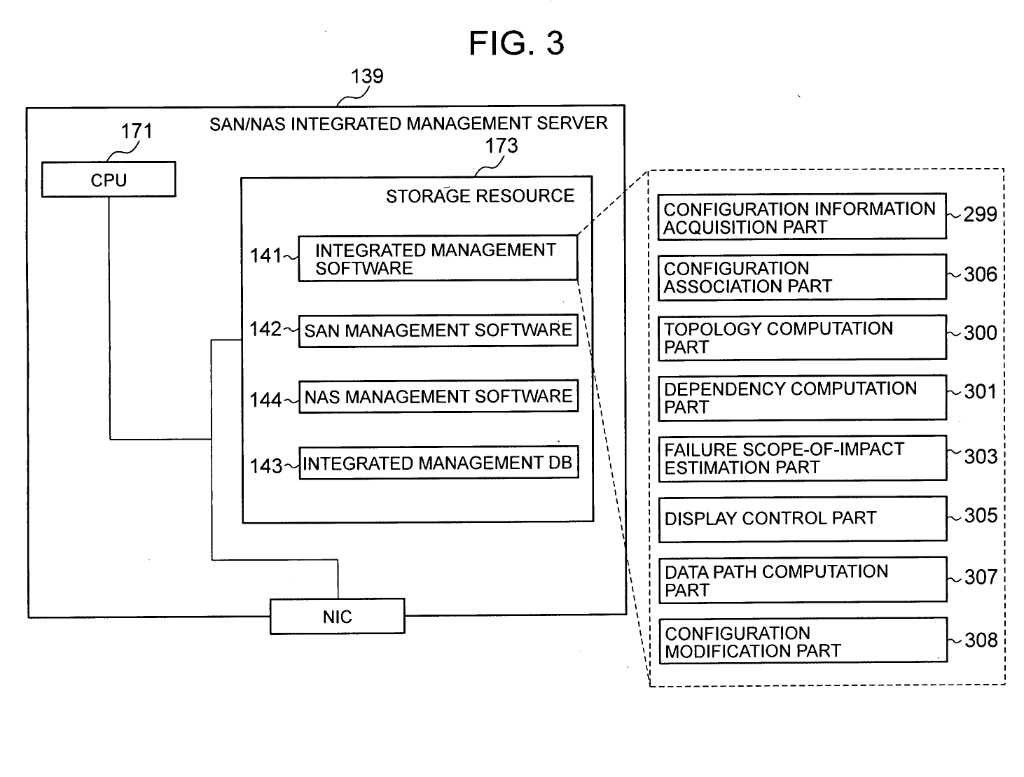

The SAN/NAS integrated management server 139, as shown in FIG. 3, comprises a CPU 171 and a storage resource 173. The storage resource 173 can be constructed using one or more of at least one type of storage device of a plurality of types of storage devices, such as memory, disks, and so forth (The same holds true for the storage resource of other computers.). For example, computer programs, such as integrated management software 141, SAN management software 142, and NAS management software 144, and an integrated management DB 143 can be stored in the storage resource 173. The respective computer programs are executed by a CPU 171. The SAN management software 142 and NAS management software 143 can be incorporated into the integrated management software 141, but they can also exist separately as in this embodiment. When computer program is used as the subject of a sentence below, in actuality, it is being processed by a CPU, which executes this computer program.

The SAN management software 142 is a computer program for managing the SAN environment, and is able to collect configuration information from a specific device belonging to the SAN environment. More specifically, the SAN management software 142 can receive, from the FC host 101 and the storage subsystem 100, respectively, various configuration information managed by the FC host 101, and configuration information managed by the storage subsystem 100 (for example, a path setup management table 231 stored in the SVP 131 or another storage resource not shown in the figure) by sending various agent programs 113 to be executed by the FC host 101, and sending various prescribed commands to the storage subsystem 100. However, the configuration information acquired from the FC host 101, for example, will comprise at least one of either an FC port WWN of the HBA possessed by the FC host 101, or a LUN mapped to the FC host 101. A path to an LDEV inside the storage subsystem 100 from the FC host 101 can be specified by associating at least a LUN or WWN inside the configuration information acquired from the FC host 101 to at least a WWN or LUN in the above-mentioned path setup management table 231. The SAN management software 142, for example, can collect configuration information from the FC host 101 and storage subsystem 100 via the LAN 109.

The NAS management software 144 is a computer program for managing a NAS environment, and is able to collect configuration information from a specific device belonging to the NAS environment. More specifically, the NAS management software 144 can receive from the NAS client 107, G-NAS 103, and NAS management client 105, respectively, configuration information, which is respectively managed by the NAS client 107, the G-NAS 103 and the NAS management client 105, by sending an agent program 121 to be executed by the NAS client 107, and sending various prescribed commands to the G-NAS 103 and NAS management client 105. However, the configuration information acquired from the G-NAS 103 here is configuration information related to the NAS environment. The NAS management software 144, for example, can respectively collect configuration information from a NAS host, NAS client, and NAS management client by way of an IP network.

The integrated management software 141 is a computer program for uniformly managing the SAN environment and the NAS environment. The integrated management software 141 can be comprised as a plurality of types of program modules, such as, for example, a configuration information collection part 299, configuration association part 306, topology computation part 300, dependency computation part 301, failure scope-of-impact estimation part 303, data path computation part 307, display control part 305, and configuration modification part 308.

The configuration information collection part 299 can collect respective types of configuration information by executing the SAN management software 142 and the NAS management software 144.

The configuration association part 306 can analyze a plurality of types of configuration information that has been collected, and associate (for example, link) each of the plurality of types of configuration information to other configuration information of this plurality of types of configuration information (More specifically, for example, it is able to mutually associate configuration information by finding the same type of information elements, and creating associations between these same type of information elements.).

The topology computation part 300 is capable of computing (in other words, determining) the topology of elements in a SAN/NAS system on the basis of respective types of associated configuration information. Here, “topology” as used in this embodiment means the connection relationship of elements in a specific scope of a SAN/NAS system. The specific scope can be the entire SAN/NAS system, or it can be individual physical devices, such as the storage subsystem, FC host, and the like.

The dependency computation part 301 is able to compute (in other words, determine) the dependency of elements in a SAN/NAS system based on the respective types of associated configuration information. Here, “dependency” as used in this embodiment is a relationship for determining which element is impacting a certain element. In other words, when a certain element is treated as a reference point, an element which impacts on this reference point constitutes an element which is dependent on the certain element. Dependency can be computed using a variety of methods, but in this embodiment, dependency information, which denotes an element that is dependent on each type of element, is stored in a storage resource (for example, a memory) of the integrated management server 139, and the dependency computation part 301 can compute the dependency by referencing this dependency information as needed. More specifically, for example, the dependency computation part 301 can specify an element, which is dependent on a specified element, by referencing dependency information, and subsequently can specify another element, which is dependent on a specified element, by referencing this dependency information. By continuing processing like this, it is possible to specify all the elements that are dependent on a specified element. Furthermore, in this embodiment, simply calling something an “element” signifies an element of the SAN/NAS system, and, more specifically, for example, signifies at least one of a so-called “device” such as a NAS client, NAS host, FC host, or storage subsystem, a physical device element in this device (for example, a port), and a logical device element in this device (for example, a file system).

The failure scope-of-impact estimation part 303 is able to estimate, based on various types of associated configuration information, which other elements will be impacted when a failure occurs in a certain element in the SAN/NAS system. Here, “failure scope-of-impact” as used in this embodiment is a relationship for determining which elements a certain element impacts. In other words, when a certain element is treated as a reference point, an element which is impacted by this reference point constitutes an element which falls into the failure scope-of-impact. The failure scope-of-impact can be computed using various methods, but in this embodiment, for example, failure scope-of-impact information denoting an element in the failure scope-of-impact for each type of element is stored in a storage resource (for example, a memory) of the integrated management server 139, and the failure scope-of-impact estimation part 303 can compute a failure scope-of-impact by referencing this failure scope-of-impact information as needed. More specifically, for example, the failure scope-of-impact estimation part 303 can specify an element, which is in the failure scope-of-impact of a specified element, by referencing failure scope-of-impact information, and can subsequently specify another element, which is in the failure scope-of-impact of a specified element, by referencing failure scope-of-impact information. By continuing this processing, it is possible to specify all the elements in the failure scope-of-impact of a specified element.

The data path computation part 307 can compute a data path in the SAN/NAS system. Here, “data path” as used in this embodiment signifies the logical connection relationship between data elements (for example, an LU, file system, application program, and so forth), which constitute reference points. More specifically, for example, it signifies a path connecting a storage device, in which data exists, with an access source for accessing this storage device.

The display control part 305 can perform various display controls, more specifically, it can display the above-mentioned computer topology, and at that time, can display objects of specific elements related to a computed dependency, failure scope-of-impact, and data path using a display mode that differs from that of the objects of the other elements (Hereinafter, a display in a different display mode will be called a “highlighted display”.). An object can take a variety of forms, such as a diagram, character, line, and so forth.

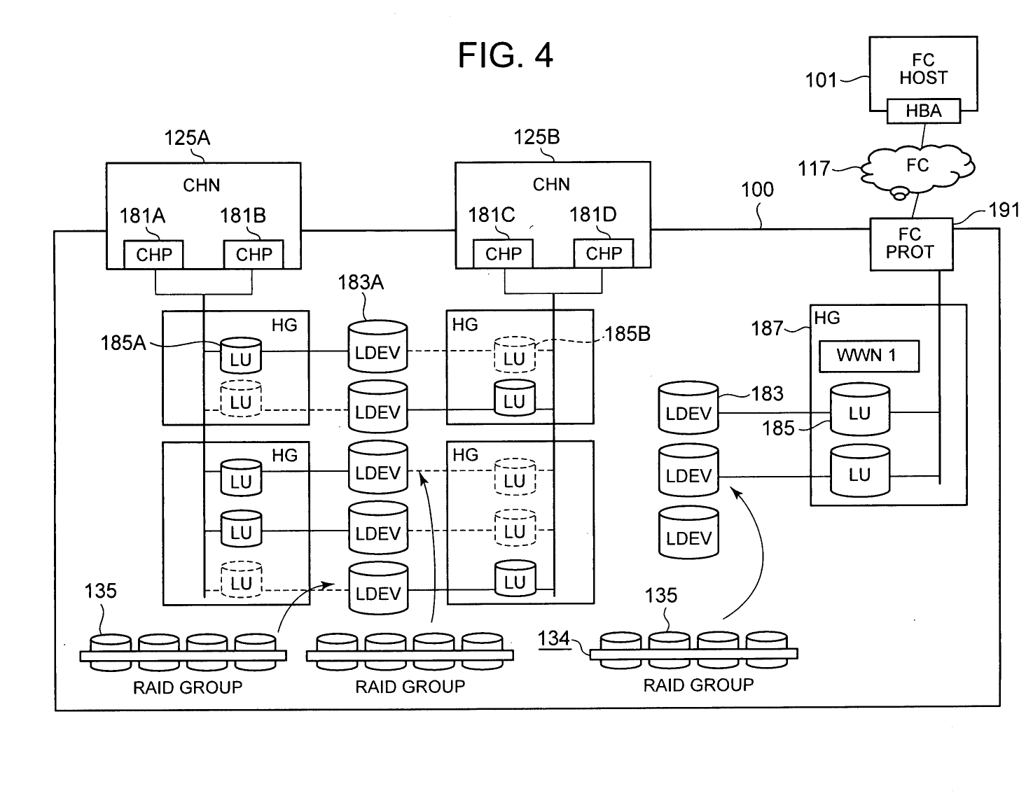

FIG. 4 shows a concept of configuration information, which is managed by a storage subsystem 100.

A storage subsystem 100 comprises a plurality of RAID groups (also called parity groups and array groups) 134. Each RAID group 134 is a group that adheres to the rules of RAID (Redundant Array of Independent (or Inexpensive) Disks), and comprises a prescribed number of two or more disks 135. One or a plurality of logical storage devices (hereinafter, LDEV) 183 are made available in accordance with the storage space provided by a RAID group 134. One logical volume (Hereinafter, this will be called a logical unit, and will be abbreviated as “LU”.) 185 is provided by one or a plurality of LDEV 183.

Further, as one of its security functions, the storage subsystem 100 has a host group function. Host group function refers to a function, which treats one or more LU as one group (hereinafter, a host group) 187, and allows access to a LU 185 belonging to this host group 187 only to a host which has been assigned access authority to this host group. A host port WWN (World Wide Name), for example, is allocated to the host group 187 as a host identifier (hereinafter, ID). Further, in the storage subsystem 100, the host group ID and the ID of a LU belonging to this host group (hereinafter, referred to as a Logical Unit Number (LUN)) are associated.

In this storage subsystem 100, a path inside the storage subsystem 100 is defined by combining a port ID, host group, LUN and LDEV-ID. Here, in the SAN environment, the port ID is the ID of a communication port (hereinafter, FC port) 191 connected to an FC network 117. A plurality of FC ports 191 is mounted in a single CHA 127. Conversely, in the NAS environment, the port ID is the ID of the CHN 125. That is, regardless of the number of communication ports mounted in the CHN 125, the CHN 125 is managed as a single port.

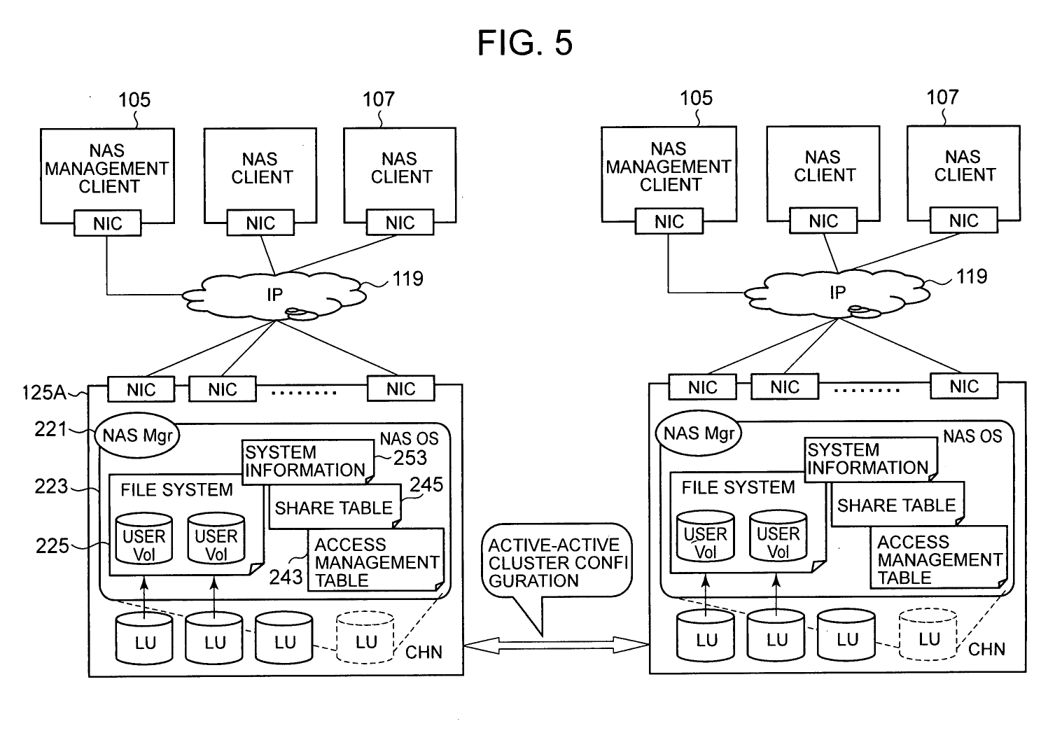

Furthermore, in the storage subsystem 100, both the CHN 125 and CHA 127 are redundant. In FIG. 4, CHN 125 is shown as a typical example of redundancy. CHN 125A and CHN 125B constitute a cluster. For example, both CHN 125A and 125B are normally active, and each microprocessor (hereinafter, CHP) 181A, 181b of CHN 125A can access LDEV 183A by way of LU 185A as indicated by the solid lines, and similarly, CHN 125B can access LDEV via the LU of the solid lines. If CHN 125A is blocked, CHN 125B is also able to access LU 185B as indicated by the broken lines, and can access LDEV 183A via theses LU 185B. FIG. 5 shows a detailed example of this redundancy. The operating systems (hereinafter, NAS OS) 223 of the respective CHN 125A, 125B are able to manage such information as a file system (FS) 225, system information (for example, information managed by the partner CHN constituting the cluster) 253, a share table 245, and an access management table 243 (The respective types of information will be explained hereinbelow.). A NAS manager (computer program) 221, in accordance with a request from the SAN/NAS integrated management server 139, can provide the SAN/NAS integrated management server 139 with information managed by the NAS OS 223. Further, both an NIC and a FC port can be provided in a CHN 125.

The respective types of configuration information aggregated in the SAN/NAS integrated management server 139 will be explained hereinbelow.

First, an example of the configuration information collected from the storage subsystem 100 will be explained.

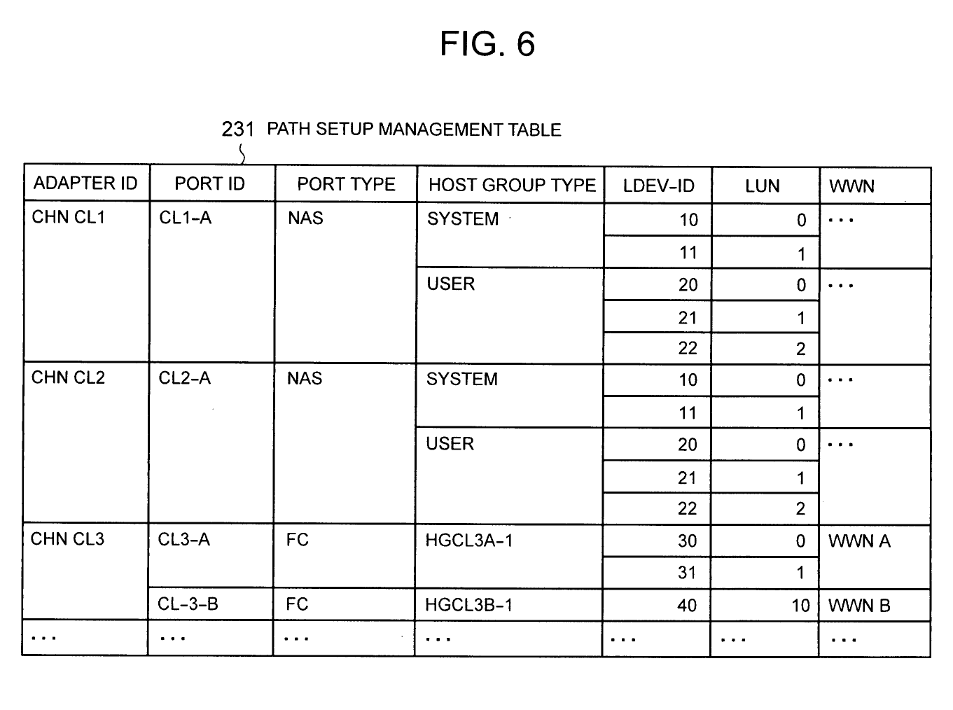

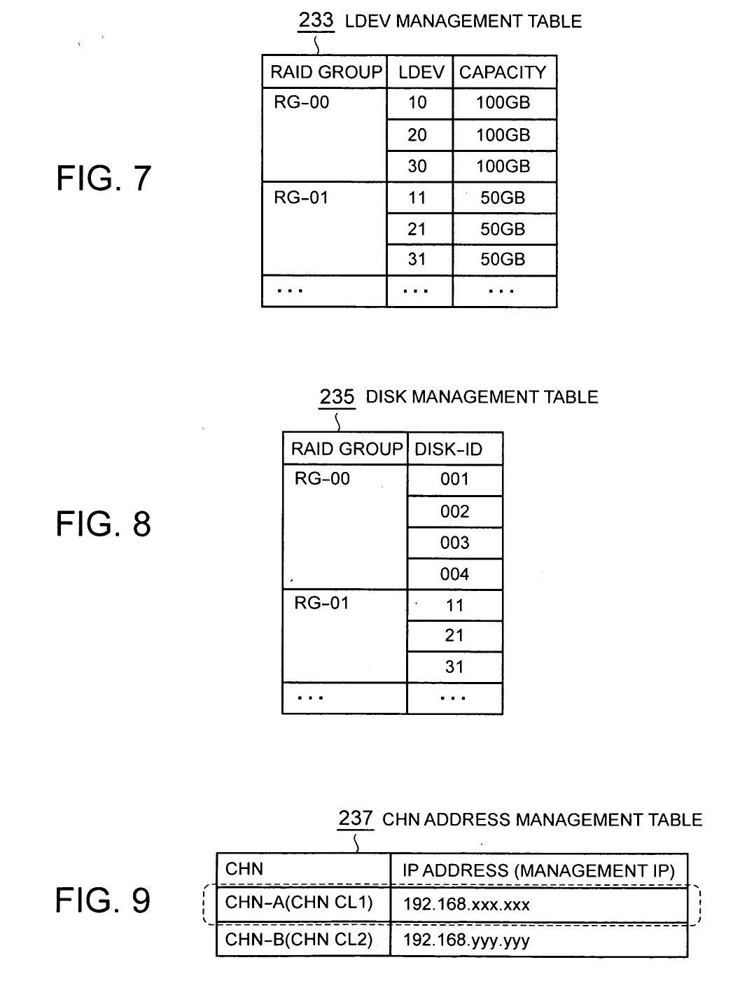

As configuration information collected from the storage subsystem 100, for example, there is the path setup management table 231 illustrated in FIG. 6, the LDEV management table 233 illustrated in FIG. 7, the disk management table 235 illustrated in FIG. 8, and the CHN address management table 237 illustrated in FIG. 9. When a CHN processor or a CHA processor accesses an LDEV in accordance with an I/O command received via any of the plurality of communication ports (FC port or NIC), access to the LDEV can be controlled on the basis of this configuration information.

The path setup management table 231 (FIG. 6) is a table for managing the establishment of a path. In this table 231, an adapter ID, port ID, port type, type of host group allocated to an adapter, LDEV ID allocated to an adapter, LUN associated to an LDEV, and FC port WWN is recorded for each adapter 125, 127. In accordance with this table 231, the port ID and WWN of each port in a CHA is managed, but for a CHN, the CHN itself is treated as a single port regardless of the number of communication ports the CHN has.

The LDEV management table 233 (FIG. 7) is a table for managing an LDEV. In this table 233, the ID of a RAID group and the ID and storage capacity of each LDEV provided by a RAID group are recorded for each RAID group. It is constituted such that the LDEV-ID of the path setup management table 231 can be used to identify which RAID group ID this LDEV-ID corresponds to and how much storage capacity this LDEV-ID has.

The disk management table 235 (FIG. 8) is a table for managing a disk 135. In this table 235, the ID of a RAID group, and the ID of each disk 135 constituting this RAID group are recorded for each RAID group. Referencing this table 235 using the above-mentioned specified RAID group ID makes it possible to specify a disk ID corresponding to this RAID group ID.

The CHN address management table 237 (FIG. 9) is a table for managing a CHN address. In this table 237, an adapter ID and management IP (IP address) are recorded for each CHN 125. It is not possible to specify the CHN 125 partners using only information managed by the storage subsystem 100, but the integrated management software 141 (in particular, the configuration association part 306) can associate the information elements in this table 237 (for example, the information elements inside the dotted line of FIG. 9) to the information elements in the system information 253 (for example, the information elements inside the dotted line of FIG. 14) from an adapter ID and management IP, and a backend ID and management IP in the system information (refer to FIG. 14) that can be acquired from a CHN 125.

The configuration information illustrated in FIGS. 6 through 9 is stored in the SVP 131 and/or other storage areas (for example, any of the SM 401, CM 402, and disks 135) of the storage subsystem, and the SVP 131 can send this variety of types of stored configuration information to the SAN/NAS integrated management server 139 in response to a prescribed command received from the SAN/NAS integrated management server 139 via a management port (for example, a NIC). Additionally, configuration information capable of being acquired from the storage subsystem can be information denoting the WWN of the respective communication ports, and the LUNs allocated to these communication ports. In addition to the configuration information described hereinabove, for example, the SVP 131 can also notify the SAN/NAS integrated management server 139 of an event (for example, an element in which a failure has occurred) detected by the storage subsystem 100.

The preceding is one example of the configuration information collected from the storage subsystem 100.

Next, an example of configuration information related to the NAS environment will be explained. As configuration information related to the NAS environment, there is configuration information collected without regard to whether it is E-NAS or G-NAS (hereinafter, common NAS configuration information), configuration information collected when it is E-NAS (hereinafter, E-NAS configuration information), and configuration information collected when it is G-NAS (hereinafter, G-NAS configuration information.).

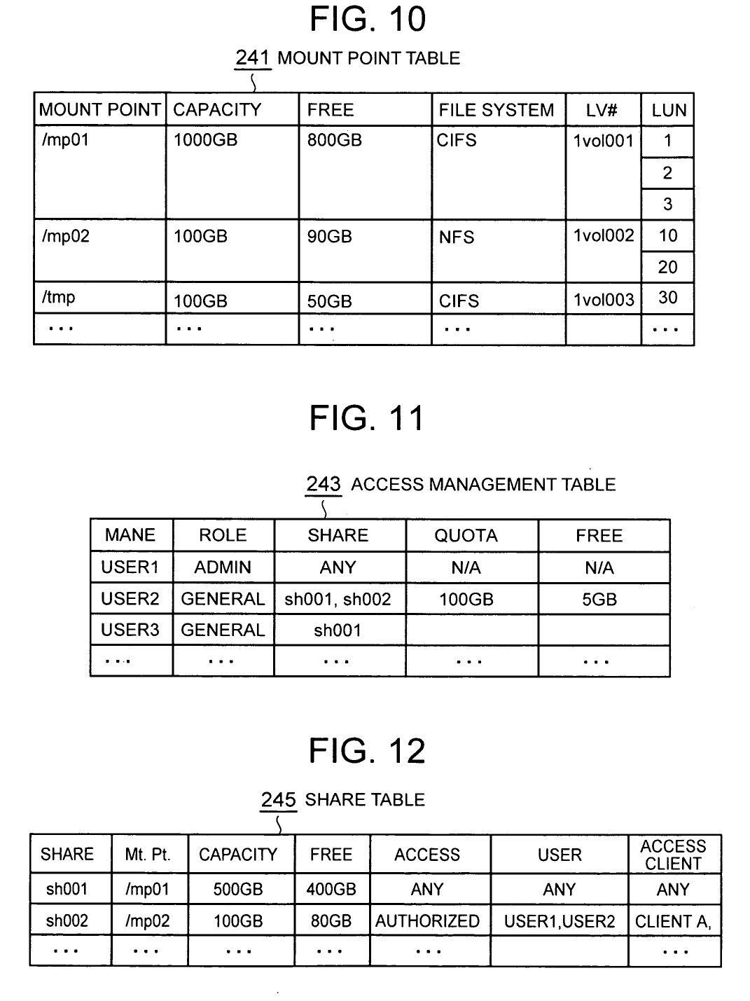

As common NAS configuration information, for example, there is the mount-point table 241 illustrated in FIG. 10, the user access management table 243 illustrated in FIG. 11, and the share table 245 illustrated in FIG. 12.

The mount-point table 241 (FIG. 10) is a table for managing a mount point, and is collected from G-NAS and E-NAS. In this table 241, a mount-point ID, a storage capacity, the free space of this storage capacity, the type of file system being used, the ID of the volume group being provided, and the respective LUN constituting this volume group are recorded for each mount point in G-NAS and E-NAS.

The access management table 243 (FIG. 11) is a table for managing users, and is collected from G-NAS and E-NAS. In this table 243, a user name, user role (for example, administrator, guest, and so forth), share area ID, the storage capacity of this share area, and the free space of this storage capacity are recorded for each user for G-NAS and E-NAS.

The share table 245 (FIG. 12) is a table for managing a plurality of user share areas (for example, a share folder, or share file). In this table 245, a share area ID, mount point ID, a storage capacity, the free space of this storage capacity, type of access authority, ID of an access-enabled user, and an ID of an access-enabled NAS client are recorded for each share area.

The preceding is one example of common NAS configuration information. In addition to this common NAS configuration information, there is configuration information collected from the NAS client 107 (or the NAS management client 105). As this configuration information, for example, there is network configuration information (for example, one's own IP address), and share area allocation information (the share area being allocated). The configuration association part 306, for example, can associate a NAS client to a NAS host by associating an information element in this configuration information (for example, a share area ID) to an information element in the configuration information managed by the NAS host (for example, a share area ID). The NAS client 107 (or the NAS management client 105) can also notify the SAN/NAS integrated management server 139 of information related to an event (for example, a failure) detected by the NAS client 107. Furthermore, the IP addresses of the respective service ports of the NAS host (communication ports connected to a NAS client) can be included in the configuration information of the NAS host. Further, the configuration information of a NAS client can also comprise at IP address used at access time. When a service port IP address and the IP address used by a NAS client coincide, the NAS host and NAS client can be associated.

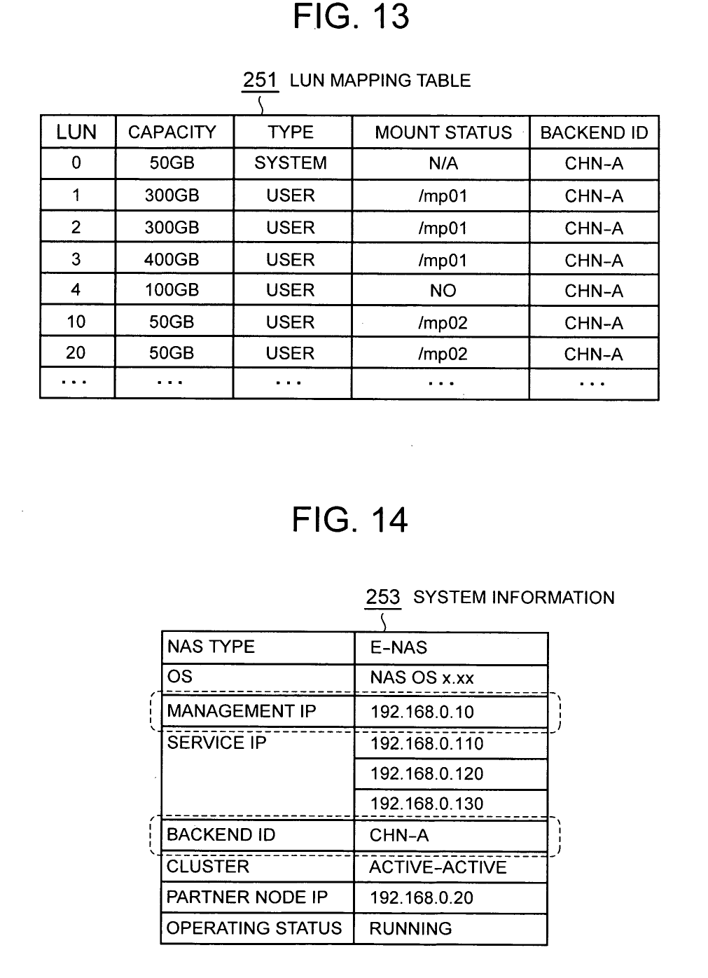

As E-NAS configuration information, for example, there is the LUN mapping table 251 illustrated in FIG. 13, and the system information 253 shown in FIG. 14.

The LUN mapping table 251 (FIG. 13) is a table for managing a LUN mapped to an E-NAS, and is collected from the E-NAS. In this table 251, the storage capacity of the LU of a LUN, the LU type (For example, it is a system LU in which an OS or the like is stored, but is it a user LU in which data read from and written to a host is stored.), mount status (for example, whether it is mounted or not), and a backend ID (the CHN ID to which it is mapped) are recorded for each mapped LUN. For example, when CHN 125A having CHN-A is blocked, the backend ID switches from CHN-A to “CHN-B”, the ID of the other CHN 125B constituting the cluster.

System information 253 (FIG. 14) is information for managing an E-NAS. In this information 253, for example, the NAS type (for example, E-NAS or G-NAS), the NAS OS type, the management IP, one or a plurality of service IPs, a backend ID, the cluster status, a partner node IP (management IP of partner CHN constituting the cluster), and operating status are recorded. Since this system information 253 is information collected from the E-NAS, the NAS type for this information 253 is E-NAS. Further, the management IP is a NIC IP address for exchanging information with the SAN/NAS integrated management server 139. By contrast, a service IP is a NIC IP address for exchanging information with a NAS client.

The preceding is one example of E-NAS configuration information. The E-NAS (CHN) can also notify the SAN/NAS integrated management server 139 of information related to an event (for example, the occurrence of a failure) detected by the E-NAS.

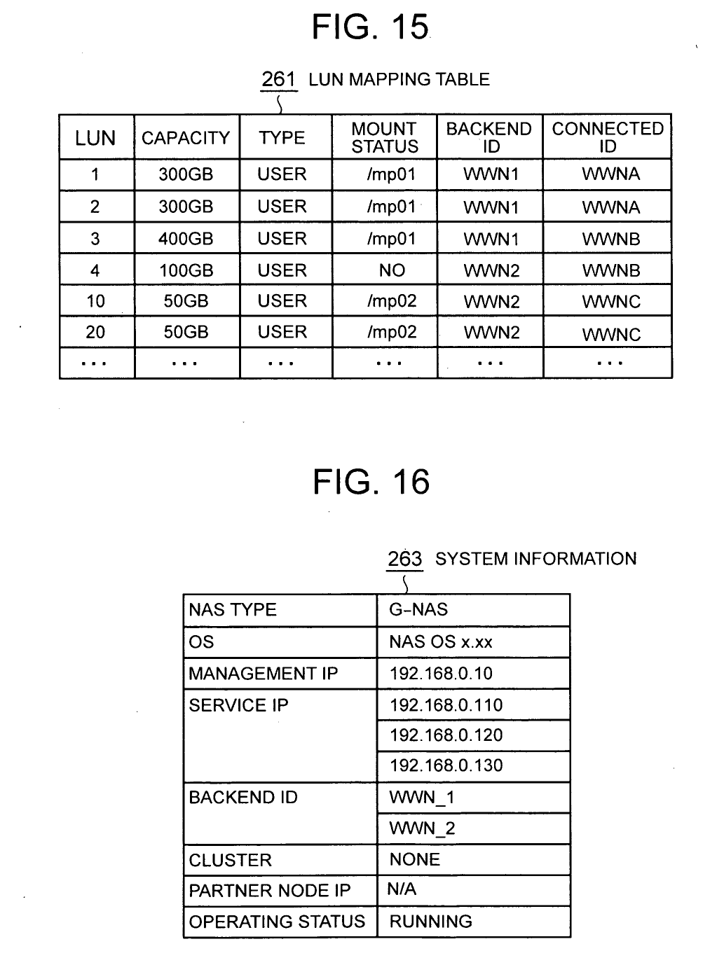

As G-NAS configuration information, for example, there is the LUN mapping table 261 illustrated in FIG. 15, and the system information 263 shown in FIG. 16.

The LUN mapping table 261 (FIG. 15) is approximately the same configuration as that of the LUN mapping table 251 illustrated in FIG. 13, and the main points of difference are the fact that the information stored as a backend ID is a WWN, and the fact that a connected ID is also recorded. The WWN recorded as the backend IDs are the WWN of the FC ports of the G-NAS. The WWN recorded as the connected IDs are the WWN of the FC ports of the storage subsystem.

The system information 263 (FIG. 16) is approximately the same configuration as that of the system information 253 shown in FIG. 14. The main point of difference is the fact that the WWN of the respective FC ports of the G-NAS are recorded as backend IDs. Furthermore, since this system information 263 is information collected from the G-NAS, the NAS type in this information 263 is G-NAS. Further, the management IP is a NIC IP address for exchanging information with the SAN/NAS integrated management server 139. By contrast, a service IP is a NIC IP address for exchanging information with a NAS client.

The preceding is one example of G-NAS configuration information. The G-NAS can also notify the SAN/NAS integrated management server 139 of information related to an event (for example, the occurrence of a failure) detected by the G-NAS.

Furthermore, the occurrence of a failure has been cited as the event information (information related to an event) notified to the SAN/NAS integrated management server 139, and examples of elements in which failures occur are as follows. That is, in the NAS host (either the E-NAs or G-NAS), for example, there are the NAS device constitution parts, built-in HDD, and connection I/F (NIC, HBA) as hardware, and as software, for example, there are the NAS OS, File System, share area, and cluster. In the storage system, for example, there are the configuration information of the storage subsystem, built-in HDD, and connection I/F (FC, NAS Port). In an FC host or NAS client, as hardware, for example, there are the device parts, built-in HDD, and connection I/F (NIC, HBA), and as software, for example, there are the NAS OS, File System, share area, and cluster. In the storage system, for example, there are the OS, File System, and application program (hereinafter, application, or just app). In the fibre channel switch, for example, there are the device parts and connection I/F (FC Port).

The processing carried out by the integrated management software 141 will be explained below.

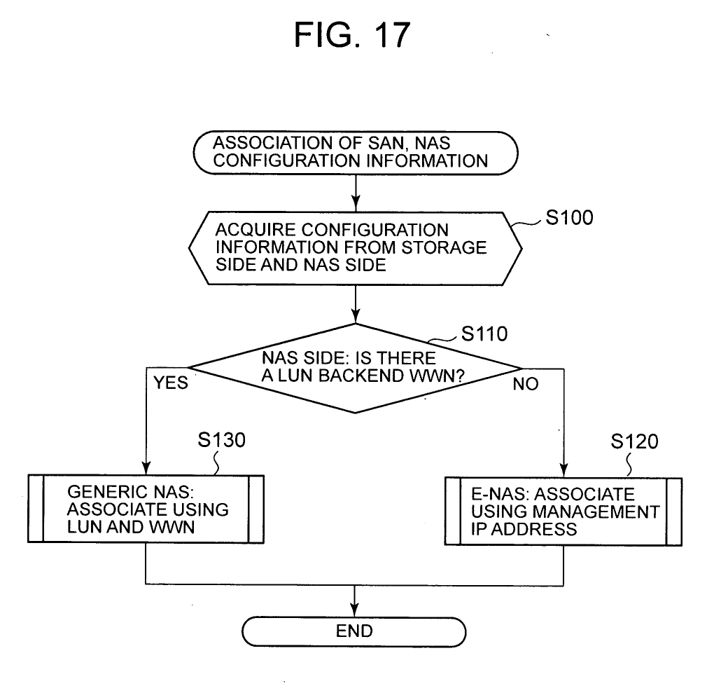

FIG. 17 shows an example of the SAN/NAS association process carried out by the integrated management software 141.

The configuration information collection part 299 respectively acquires configuration information managed by the storage subsystem 100, configuration information managed by an E-NAS, configuration information managed by a G-NAS, and configuration information managed by a NAS client by respectively executing the SAN management software 142 and the NAS management software 144 (Step S100). The acquired respective configuration information is managed by the integrated management DB 143.

The configuration association part 306 references the LUN mapping tables 261, 263 of the configuration information acquired, and checks whether or not the backend IDs recorded in these tables 261, 263 are WWN (S110). If the results of this check are not WWN (S110: NO), the configuration association part 306 executes S120, and if they are WWN (S110: YES), it executes S130.

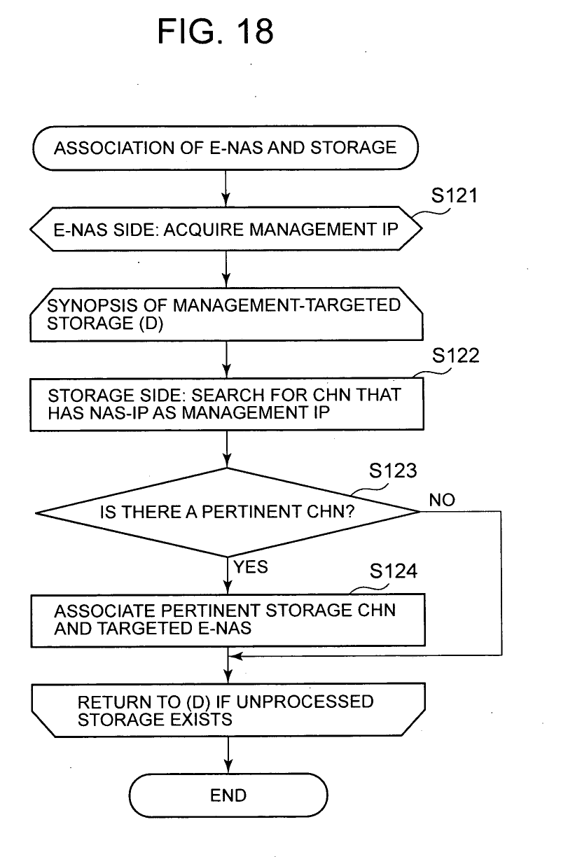

FIG. 18 shows an example of the flow of processing for carrying out S120 of FIG. 17, that is, for the association of the E-NAS and storage subsystem.

The configuration association part 306 acquires a management IP inside the system information 253 from the E-NAS 125 (S121). The configuration association part 306 carries out S122 through S124 for all the storage subsystems targeted for management (all configuration information-providing storage subsystems). That is, the configuration association part 306 searches for an acquired management IP in the CHN address management table 237 (S122), and if the same IP address as this management IP is recorded in this table 237 (S123: YES), it associates this IP address to the management IP (S124). If S123 is NO, the configuration association part 306 carries out S122 for a storage subsystem that has not been processed yet.

In accordance with the processing shown in this FIG. 18, it is possible to associate the E-NAS 125 to a storage subsystem 100. Furthermore, an identifier (for example, a DNS host name) assigned under a prescribed environment (for example, a management network for managing the respective devices) can be used instead of the management IP and IP address. Further, in the above-mentioned association, another type of CHN identifier, such as a backend ID (or a CHN number) possessed by the E-NAS and a port ID possessed by a storage subsystem can be utilized instead of the management IP and IP address. Further, a LUN mapped to the E-NAS and a LUN inside a storage subsystem can be used instead of these.

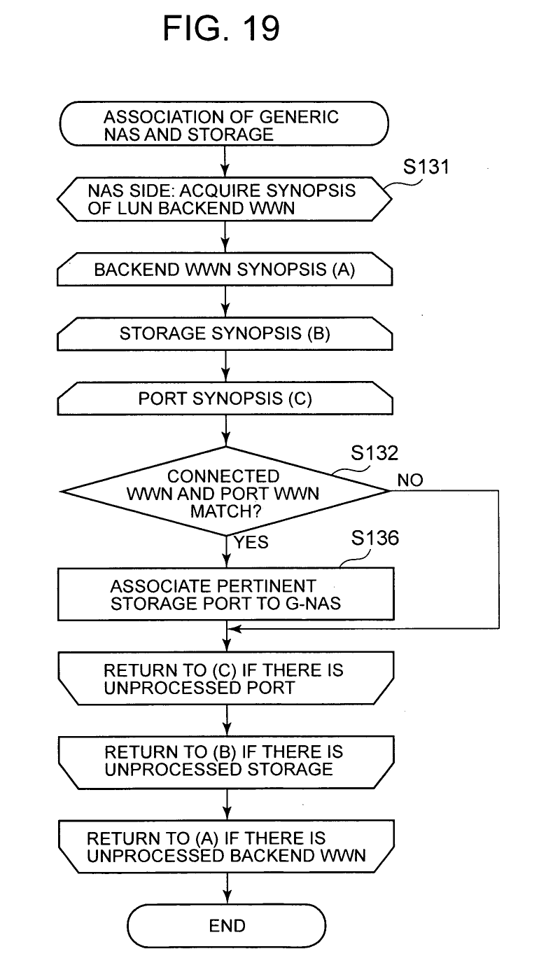

FIG. 19 shows an example of the flow of processing for carrying out S130 of FIG. 17, that is, for associating the G-NAS to a storage subsystem.

The configuration association part 306 acquires all connected IDs (connected WWN) from the LUN mapping table 261 of the G-NAS 103 (S131). The configuration association part 306 carries out S132 and S133 for all connected WWN that have been acquired, all management targeted storage subsystems (all configuration information-providing storage subsystems), and all the FC ports of each storage subsystem. That is, if the acquired connected WWN coincide with the FC port WWN in the configuration information acquired from a storage subsystem (S132: YES), the configuration association part 306 associates the connected WWN in the LUN mapping table 261 to the FC port WWN in the configuration information acquired from the storage subsystem.

In accordance with the processing shown in this FIG. 19, it is possible to associate the G-NAS 103 to a storage subsystem 100. Furthermore, the configuration information of the G-NAS can comprise the WWN of its own FC ports (G-NAS port WWN), and the configuration information of the storage subsystem can comprise the WWN of an FC port of its own FC port allocated source (allocated source WWN). In this case, the configuration association part 306, either in place of or in addition to the determination of S132 (hereinafter, the first determination), can make a determination (a second determination) as to whether or not a G-NAS port WWN coincides with an allocated source WWN, and when the second determination results in a match, can carry out association. If association is carried out when there is a match in both the first and second determinations, it is possible to ensure that the storage subsystem and G-NAS are physically connected. Furthermore, this can also be applied to the association of a storage subsystem and an FC host.

Based on the various types of configuration information associated via the above series of processes, the topology computation part 300 is able to compute the topology of the elements in the SAN/NAS system, and the display control part 305 is able to plot the computed topology. The computed topology, for example, is displayed as a GUI (Graphical User Interface). A topology, for example, has a logical topology (hereinafter, logical topology) and a physical topology (hereinafter, physical topology), and the topology computation part 300 can compute both of these topologies. The display control part 305 can switch between a logical topology and a physical topology, and can display them side by side on a single screen, or can overlap them on a single screen.

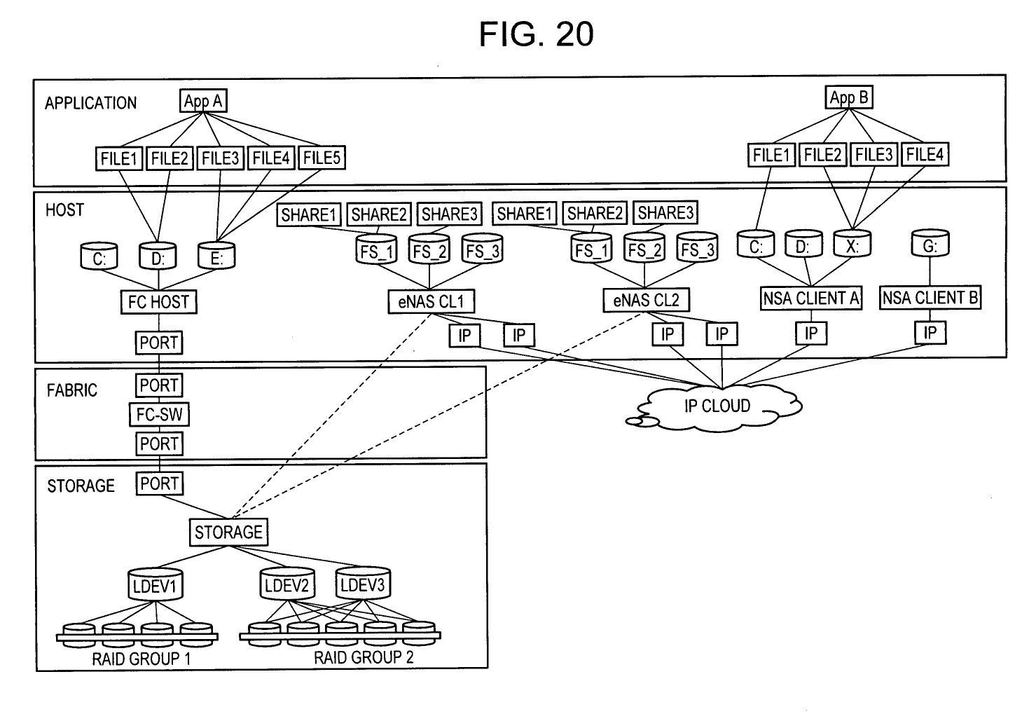

FIG. 20 shows an example of a logical topology GUI. In this GUI, a topology constituted by elements other than G-NAS is shown.

A logical topology can also be called a detailed topology. The display control part 305 plots each object (for example, a diagram) denoting each element in a logical topology, and plots an object (for example, a line) denoting an association between elements that are mutually associated.

The FC port object “port” and LU objects “C:”, “D:”, “E:” are associated to the FC host object “FC host”. The fact that the FC host has one FC port, for example, can be determined by the topology computation part 300 analyzing the configuration information managed by the FC host (This configuration information, for example, can be acquired from the FC host via the LAN 109.).

Electronic file objects used by an application “File1”, “File2”, “File3”, “File4” and “File5” are associated to the object of the application “App A”, two electronic files “File1” and “File2” are associated to LU “D:”, and three electronic files “File3”, “File4” and “File5” are associated to LU “E:”. This can be determined by the topology computation part 300 analyzing the configuration information managed by the FC host. The information discussed in this paragraph also holds true for the NAS clients “NAS Client A” and “NAS Client B”.

The fibre channel switch object “FC-SW” and its FC port object “port” are plotted between the FC host “FC host” and the storage subsystem “Storage”. The interposition of the fibre channel switch can be specified by the topology computation part 300 analyzing the configuration information from this fibre channel switch. The configuration information managed by the fibre channel switch can be acquired via a prescribed I/F. Further, the number of FC ports possessed by this fibre channel switch can be specified by the topology computation part 300 analyzing this configuration information.

LDEV objects “LDEV 1”, LDEV 2” and LDEV 3” are associated to the storage subsystem “Storage”, and RAID group objects are associated to the respective LDEV objects. The topology computation part 300 can specify what LDEV exist in which storage subsystems, and which RAID group is associated to which LDEV from the LDEV management table 233 and disk management table 235.

Associated to the storage subsystem “Storage” is the FC port object “port” of this storage subsystem, and the E-NAS (CHN) objects “eNAS CL1” and “eNAS CL2”. The association between the E-NAS and the storage subsystem can be specified from the association resulting from the processing shown in FIG. 18.

Three file system objects “FS_{—}1”, “FS_{—}2” and “FS_{—}3” are associated to the E-NAS “eNAS CL1”, share area objects “Share1” and “Share 2” are associated to “FS_{—}1”, and “Share3” is associated to “FS_{—}2”. These associations can be specified by the topology computation part 300 analyzing the mount-point table 241, user access management table 243, and share table 245. The information discussed in this paragraph also holds true for the E-NAS “eNAS CL2”.

Two NIC objects “IP” are associated to the E-NAS “eNAS CL1”, and an IP network object “IP Cloud” is associated to this object “IP”. The topology computation part 300 can specify the E-NAS NIC from the number of service IPs in the system information 253. The information discussed in this paragraph also holds true for the E-NAS “eNAS CL2”, and the NAS clients “NAS Client A” and “NAS Client B”.

The above logical topology GUI clarifies the logical connection relationship of logical elements.

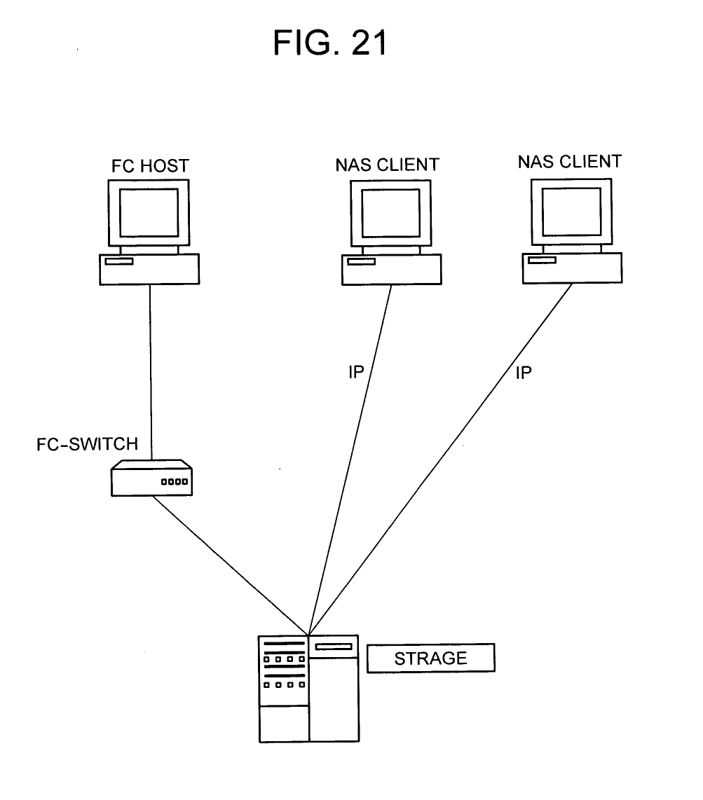

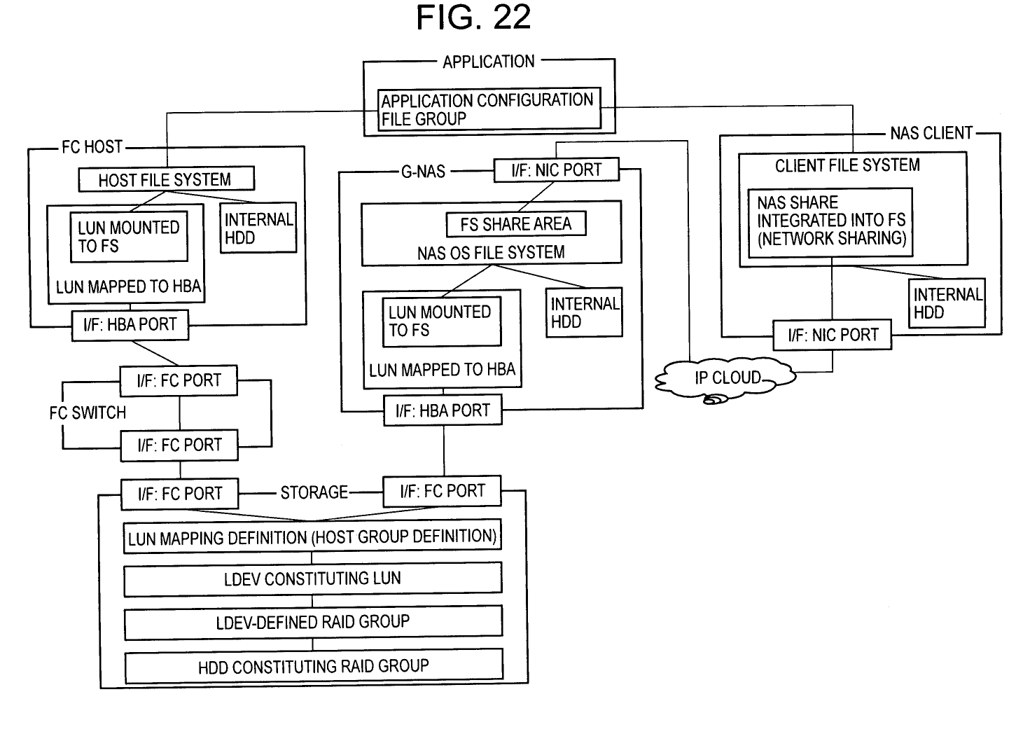

FIG. 21 shows an example of the physical topology GUI corresponding to the logical topology of FIG. 20.

The physical topology can also be called a simplified topology. The topology computation part 300 selects the FC host, fibre channel switch, storage subsystem, and NAS clients as elements of the physical topology, and the display control part 305 plots the objects of these selected elements. Further, the display control part 305 can also plot an object denoting a communication protocol (for example, characters of an abbreviation such as FC or IP) near the lines connecting the respective objects.

This physical topology clarifies the physical connection relationship of the various types of computers. If a user wants to see a more detailed topology, for example, the user issues a command to display the logical topology on this GUI. The integrated management software 141 displays the logical topology of FIG. 20 in response to this command. Upon receiving a command to display the physical topology on the GUI of the logical topology of FIG. 20, the integrated management software 141 displays the physical topology shown in this FIG. 21 in response to this command.

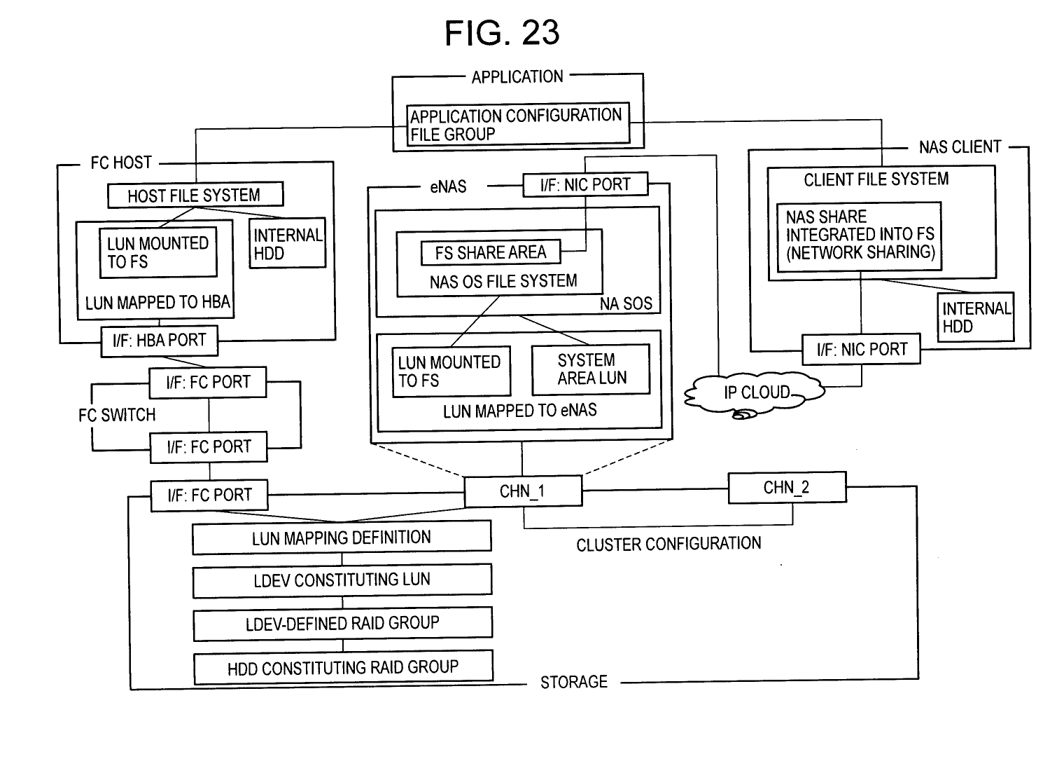

Now then, topologies such as those illustrated in FIG. 22 and FIG. 23, for example, are constructed in the SAN/NAS system (FIG. 22 shows a topology comprising the G-NAS, and FIG. 23 shows a topology comprising the E-NAS.). The integrated management software 141 not only computes a topology in the SAN/NAS system, but is also capable of computing an element which is dependent on a certain element in this topology, and of estimating the scope of impact when a failure occurs in a certain element. This dependency computation can be carried out by the dependency computation part 301, and a failure scope-of-impact computation can be carried out by the failure scope-of-impact estimation part 303. These will be explained in detail hereinbelow.

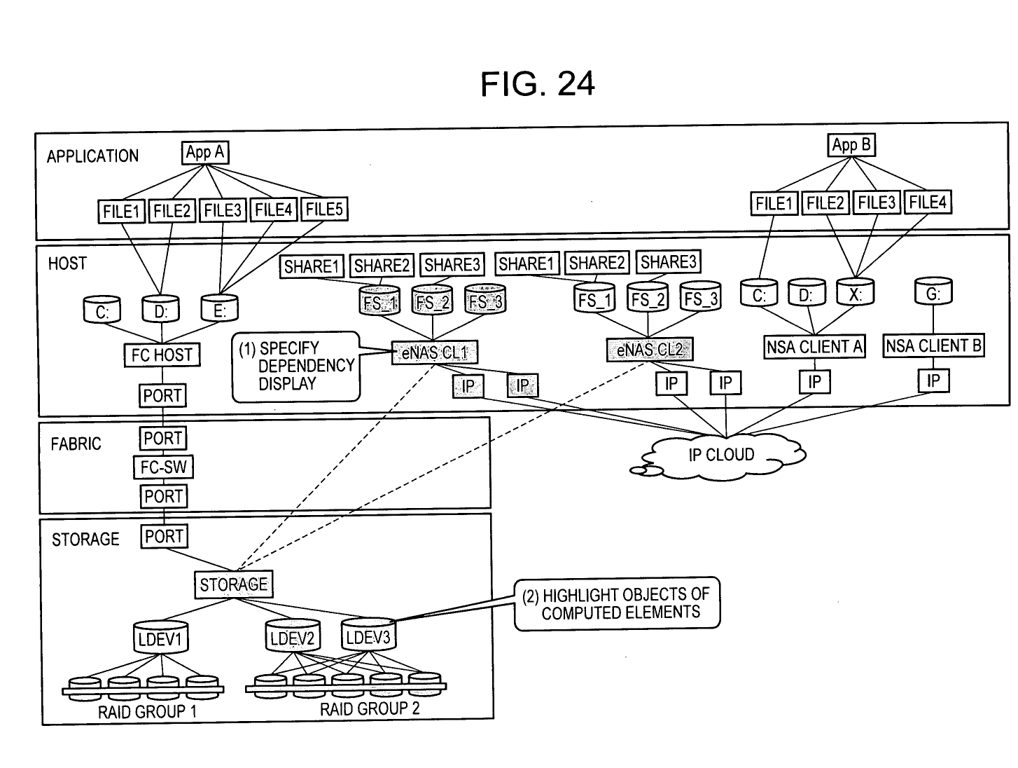

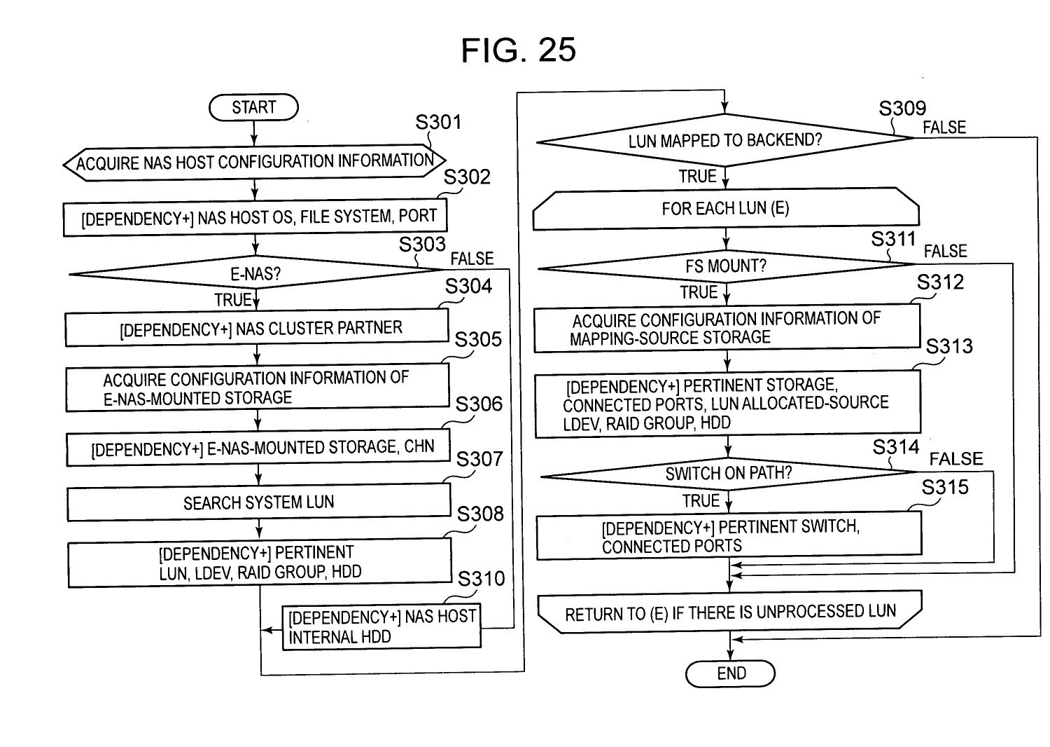

FIG. 24 shows an example of a display of the results of a dependency computation of the E-NAS “eNAS CL1”.

Each object in the GUI shown in FIG. 20, for example, is an icon capable of being specified by a pointing device (for example, a mouse) or other such input device. Receiving a specification for an object and carrying out a prescribed operation results in the dependency computation part 301 receiving a dependency computation command for the element of this object. For example, there is a choice called “dependency display” on a menu displayed by right clicking the mouse in a state wherein the mouse cursor is superimposed on an object, and when this choice is selected using the mouse, the dependency computation part 301 executes a dependency computation. The display control part 305 displays the results of this computation. For example, as an example of a display of the computation results for the object “eNAS CL1”, the objects of all elements determined to be dependent can be highlighted (The same can also be done for other dependency computations and displays.).

FIG. 25 shows an example of the flow of processing of a dependency computation for computing an element that is dependent on the NAS host.

The dependency computation part 301 executes this processing flow when a dependency display specifying a NAS host object is instructed. The dependency computation part 301 analyzes the configuration information acquired from the NAS host, which was specified (hereinafter, the specified NAS host) (S301), and determines the NAS OS, file system, and NIC in this specified NAS host to be dependent elements (S302).

When it can be determined from the results of the analysis of S301 that the specified NAS host is not the E-NAS (S303: FALSE), the dependency computation part 301 determines the internal disk (HDD) of the specified NAS host to be a dependent element (S310). The fact that the specified NAS host has an internal disk, for example, can be specified from the configuration information of the specified NAS host. This configuration information, for example, comprises the ID of the internal disk.

Conversely, when it can be determined from the results of the analysis of S301 that the specified NAS host is the E-NAS (S303: TRUE), the dependency computation part 301 determines the partner E-NAS, which constitutes the cluster, to be a dependent element (S304). The partner E-NAS can be specified from the system information of the specified NAS host. Further, the dependency computation part 301 analyzes the configuration information of the storage subsystem in which the E-NAS is mounted (S305), and determines the E-NAS-mounted storage subsystem and the E-NAS to be dependent elements (S306). Further, the dependency computation part 301 retrieves from the LUN mapping table a system LU mapped to the E-NAS (S307), and determines the retrieved LU, and the LDEV, RAID group, and disks that provide this system LU, to be dependent elements (S308). The LDEV and RAID group can be specified from the LDEV management table 233 and disk management table 235.

Subsequent to either S308 or S310, if the dependency computation part 301 was able to specify from the LUN mapping table that LUN have been mapped to the backend (S309: TRUE), S311 through S315 will be carried out for each of these LUN. That is, the dependency computation part 301 analyzes the configuration information from the specified NAS host, and determines the presence or absence of a file system mount (S311), and if there is one, analyzes the configuration information of the storage subsystem having the mapped LU (S312). Then, the dependency computation part 301 specifies this storage subsystem, the port, of the ports of this storage subsystem, to which the specified NAS host is connected, the LDEV allocated to the above-mentioned mapped LUN, the RAID group and disks, and determines each of these to be a dependent element (S313).

Further, when the dependency computation part 301 determines that there is a switch between the specified NAS host and the storage subsystem having the mapped LU (S314: TRUE), and determines this switch, and the port of this switch, which is connected to the NAS host and this storage subsystem, to be dependent elements (S315).

In accordance with the above series of processes, the elements, which are dependent on the specified NAS host, are determined.

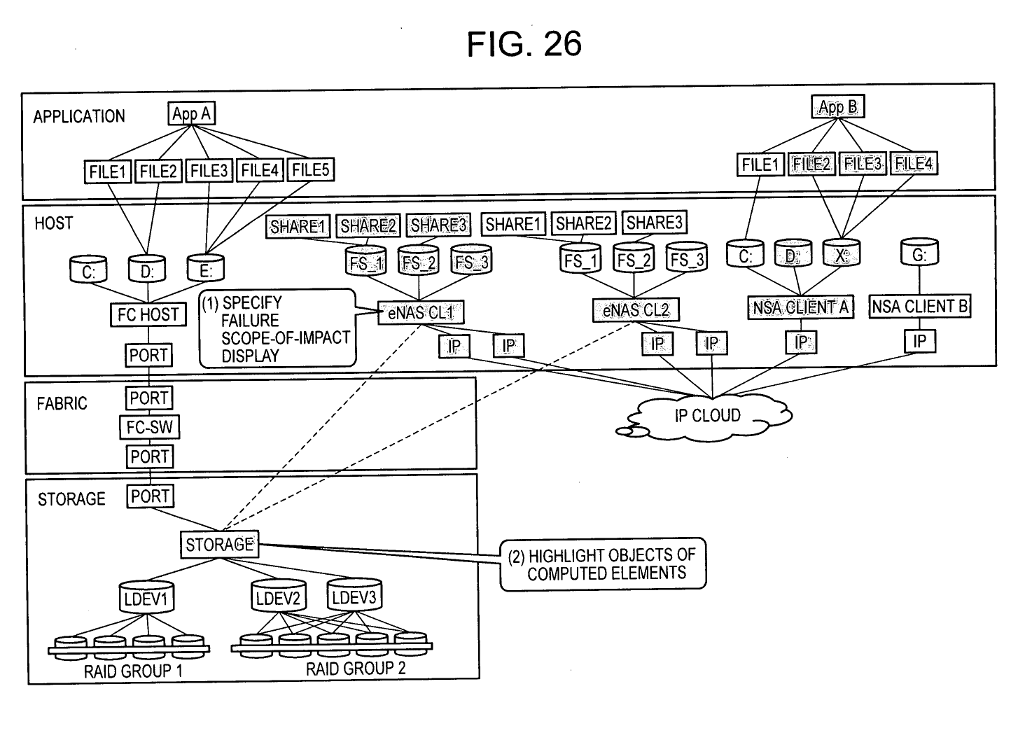

FIG. 26 shows an example of a display of the results of a failure scope-of-impact estimation for the E-NAS “eNAS CL1”.

Carrying out a prescribed operation for the user-desired element “eNAS CL1” results in the reception of a command for estimating the failure impact for this element. For example, there is a choice called “failure scope-of-impact display” on a menu, which is displayed by right clicking the mouse on the object of this element, and when this choice is selected, the failure scope-of-impact estimation part 303 executes an estimation of the failure scope of impact, and the display control part 305 displays the results of this estimation. For example, as an example of a display of the failure scope-of-impact estimation results for the object “eNAS CL1”, the objects of all elements estimated as being in the failure scope of impact are highlighted. When the degree of impact differs for these elements, a display corresponding to this degree of impact is displayed (For example, an object (for example, a mark) corresponding to the degree of impact is displayed, or the degrees of impact are displayed using different colors.). Furthermore, an estimation of the scope of a failure is not only carried out when specified by a user, and, for example, can also be carried out when a notification of a failure occurrence is received, and the element in which the failure occurred is specified from this notification. In this case, for example, an object signifying the occurrence of a failure (for example, an x mark) can be displayed for the element in which the failure occurred (for example, “eNAS CL1”). The information discussed in this paragraph can be assumed to be the same for other failure occurrence estimations and displays as well.

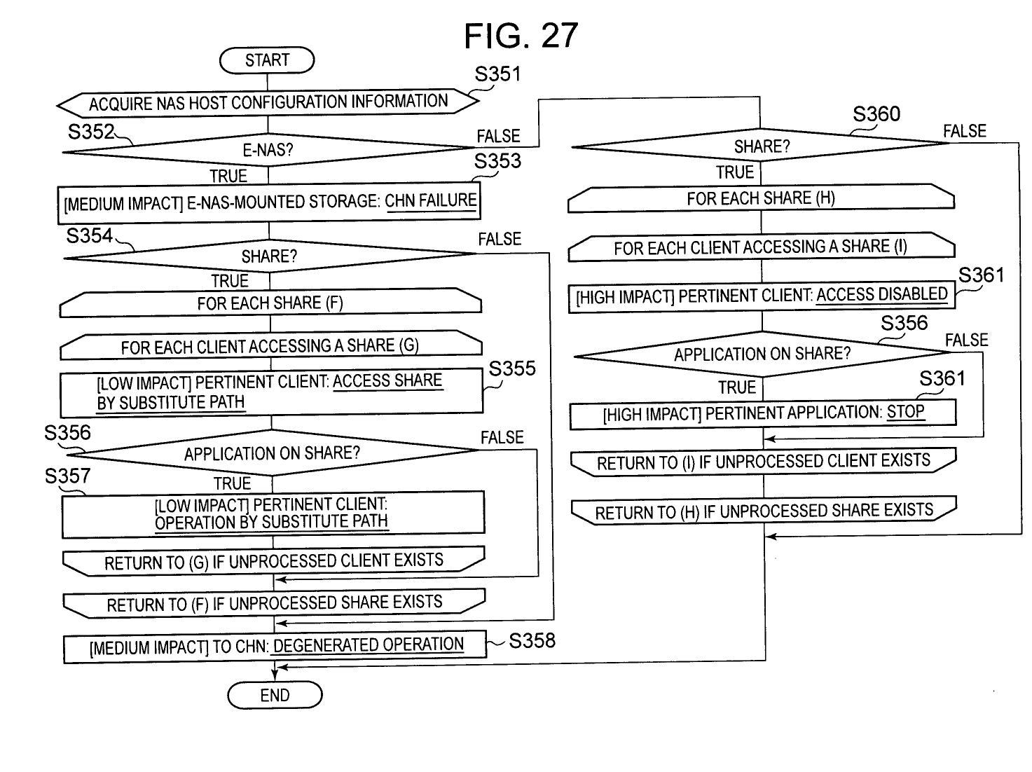

FIG. 27 shows an example of the flow of processing for estimating the failure scope-of-impact of the specified NAS host. Furthermore, in the following explanation, it is supposed that there are three degrees of impact: high, medium, and low.

The failure scope-of-impact estimation part 303 analyzes the configuration information acquired from the specified NAS host (S351).

If the results of the analysis of S351 make it possible to specify that the specified NAS host is the E-NAS (S352: TRUE), the failure scope-of-impact estimation part 303 treats the storage subsystem to which the E-NAS is mounted as an element that falls within the scope of impact, and sets the degree of impact to “medium” (S353). In addition, if it is a share area (S354: TRUE), the failure scope-of-impact estimation part 303 carries out S355 through S358 for the respective share areas, and for each NAS client, which accessed the respective share areas. That is, the failure scope-of-impact estimation part 303 treats the clients that access the respective share areas as elements that fall within the scope of impact, and sets the degree of impact to “low” (S355). Further, if there is an application program, which uses the respective share areas (S356: TRUE), the failure scope-of-impact estimation part 303 treats this application program as an element that falls within the scope of impact, and sets the degree of impact to “low” (S357). Thereafter, the failure scope-of-impact estimation part 303 also treats the partner of the E-NAS, which is the specified NAS host, as an element that falls within the scope of impact, and sets the degree of impact to “medium” (S358).

When it is determined from the results of analysis of S351 that the specified NAS host is not the E-NAS (S352: FALSE), the failure scope-of-impact estimation part 303 carries out, when there are share areas (S360: TRUE), S361 through S363 for the respective share areas, and for each NAS client, which accesses the respective share areas. That is, the failure scope-of-impact estimation part 303 treats a client, which accesses the respective share areas, as an element that falls within the scope of impact, and sets the degree of impact to “high” (S361). Further, if there is an application program, which uses the respective share areas (S362: TRUE), the failure scope-of-impact estimation part 303 treats this application program as an element that falls within the scope of impact, and sets the degree of impact to “high” (S363).

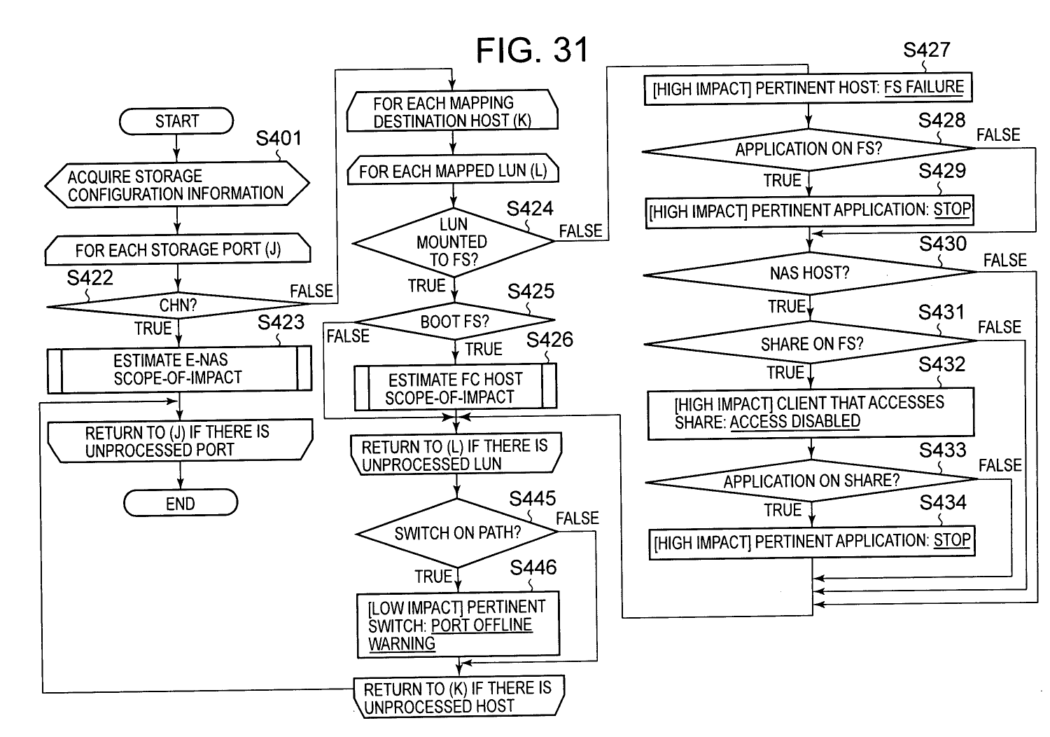

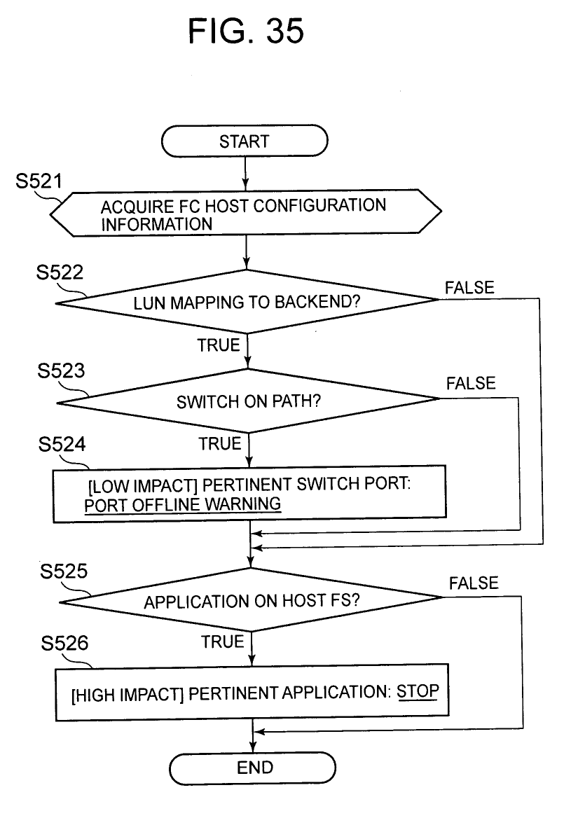

Furthermore, in the specification blocks of S353, S355, and so forth in FIG. 27, the expression following the colon “:” is underlined, indicating either a failure that could occur or a countermeasure for when an impact is received (This is also the same for FIG. 31 and FIG. 35). For example, in S355, accessing a share area via a substitute path (can also be called an alternate path) is denoted as the countermeasure for a NAS client. Further, for example, in S363, the underline signifies that the application will stop. In addition, for example, in S358, the underlined portion denotes degenerate operation, that is, the fact that the E-NAS, which is the specified NAS host, is blocked, and operation is being carried out by the partner E-NAS, which constitutes a cluster with this E-NAS. The display control part 305 can display the underlined information together with the failure scope-of-impact estimation results. For example, the control part 305 can display the underlined information when the mouse cursor is superimposed on a highlighted object. In this case, the underlined information is managed by associating it with a corresponding object.

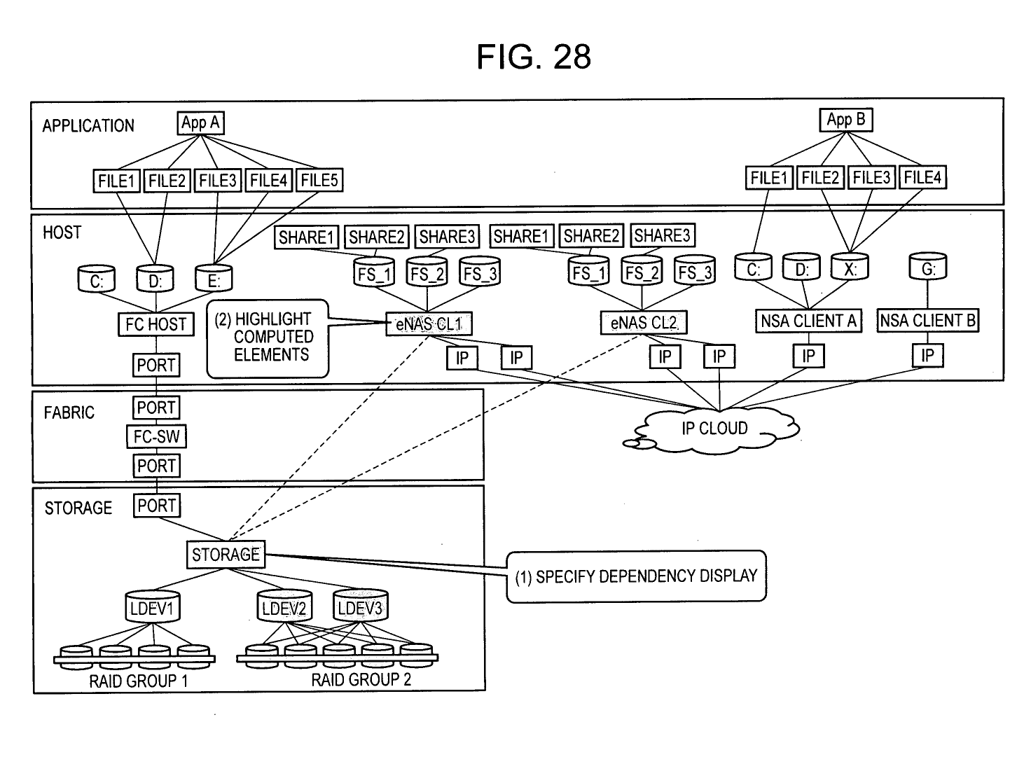

FIG. 28 shows an example of a display of dependency computation results for the storage subsystem “Storage”.

Receiving a specification for the storage system “Storage” and carrying out a prescribed operation results in the reception of a command for computing the dependency of the element of this object. For example, when “dependency display” is selected from a menu displayed by right clicking the mouse, the dependency computation part 301 computes dependency, and the display control part 305 displays the computation results.

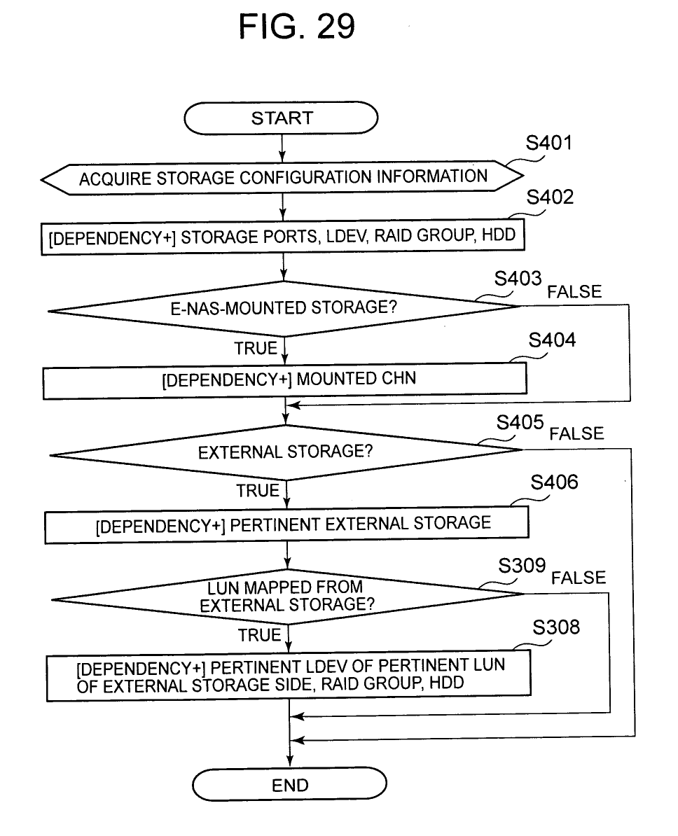

FIG. 29 shows an example of the flow of dependency computation processing for computing an element that is dependent of the specified storage system.

The dependency computation part 301 analyzes the configuration information acquired from the storage system, which has been specified (the specified storage system) (S401), and determines the port, LDEV, RAID group and disks in this specified storage subsystem to be dependent elements (S402). Further, when the dependency computation part 301, based on the analysis results of S401, specifies that the E-NAS is mounted to this storage system (S403: TRUE), it determines the mounted E-NAS to be a dependent element (S404).

In addition, when the dependency computation part 301, based on the analysis results of S401, specifies that an external storage subsystem is connected to this storage system (S405: TRUE), it determines this external storage subsystem to be a dependent element (S406). The presence or absence of an external storage subsystem, for example, can be specified in accordance with whether or not there is information related to an external storage subsystem in the configuration information. Further, if the analysis results of S401 indicate that a LUN of this external storage subsystem is mapped to the storage subsystem (S407: TRUE), the dependency computation part 301 determines the LDEV, RAID group and disks that provide the LU of this mapped LUN to be dependent elements (S408).

In accordance with the above series of processes, elements that are dependent on the specified storage. subsystem are determined. Furthermore, an example of the topology that is possible when an external storage subsystem is connected to the storage subsystem is shown in FIG. 37. That is, the storage subsystem has a virtual external volume group, and a LDEV is provided by this external volume group. Further, either one or a plurality of LUNs of the external storage subsystem is mapped to this external volume group, and a storage resource provided by this one or a plurality of LUNs is treated virtually as a volume group of the storage subsystem.

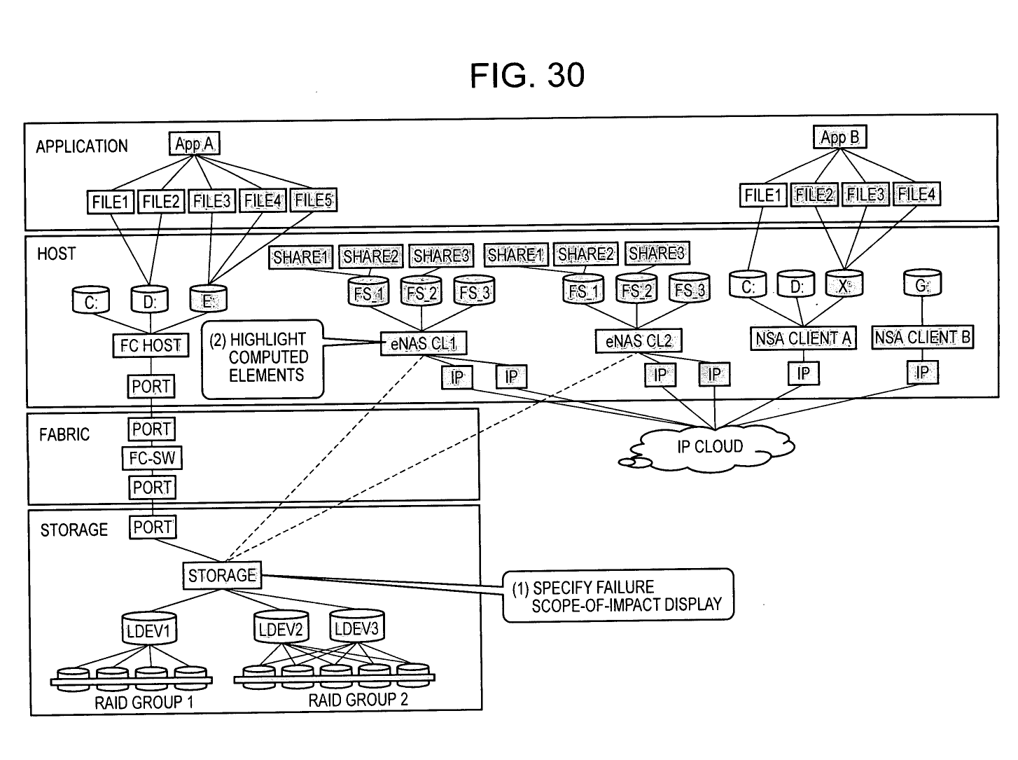

FIG. 30 shows an example of a display of the results of a failure scope-of-impact estimation for the storage subsystem “Storage”.

Performing a prescribed operation for the user-intended element “Storage” results in the reception of a failure impact estimation command for this element, and, in this case, the failure scope-of-impact estimation part 303 estimates the scope of impact of a failure, and the display control part 305 displays the estimation results.

FIG. 31 shows an example of the flow of processing of a failure scope-of-impact estimation for a specified storage subsystem.

The failure scope-of-impact estimation part 303 analyzes the configuration information acquired from a specified storage subsystem (S421). Then, the failure scope-of-impact estimation part 303 performs the processing of the following S422 and beyond for each port of this storage subsystem.

When the failure scope-of-impact estimation part 303 specifies that a port is a CHN (S422: TRUE), it performs the processing of S353 and beyond of FIG. 27 as S423. The fact that a port is a CHN can be specified from the port type of the path setup management table 231.

Conversely, when it specifies that a port is not a CHN (S422: FALSE), the failure scope-of-impact estimation part 303 carries out S424 through S446 for each mapping-destination host of this port of these, S424 through S444 are carried out for each LUN mapped to the respective mapping-destination hosts.

If a mapped LUN is a LUN, which has been mounted to a file system, and this file system is a file system for use in booting (S425: TRUE), the failure scope-of-impact estimation part 303 performs the processing shown in FIG. 35 (S426). Whether or not a LUN is mounted to a file system can be specified from the mount-point table 241. Further, whether or not a file system is a file system for use in booting (for example, a file system, which is used to boot up an OS), for example, can be specified from the configuration information in which the respective types of file systems are recorded.

Conversely, if S425 is FALSE, the failure scope-of-impact estimation part 303 treats the mapping-destination host as an element that falls within the scope of impact, and sets the degree of impact to “high” (S427). Further, if there is an application program that uses this file system (S428: TRUE), the failure scope-of-impact estimation part 303 treats this application programs as an element that falls within the scope of impact, and sets the degree of impact to “high” (S429). In addition, if the mapping-destination host is the NAS host (S430: TRUE), and the file system is a share area (S431: TRUE), the failure scope-of-impact estimation part 303 treats a NAS client, which accesses this share area, as an element that falls within the scope of impact, and sets the degree of impact to “high” (S432). Further, if there is client application program, which uses this share area, the failure scope-of-impact estimation part 303 treats this application program as an element that falls within the scope of impact, and sets the degree of impact to “high” (S444).

When there is a switch on a path, which is connected to a port of a specified storage subsystem (S445: TRUE), the failure scope-of-impact estimation part 303 treats this switch as an element that falls within the scope of impact, and sets the degree of impact to “low” (S446). Furthermore, the underline in S446 denotes that a port offline warning is coming from the switch. A port offline warning, for example, is a warning that is issued when a port connected to the storage subsystem ceases exchanging signals due to a storage subsystem failure.

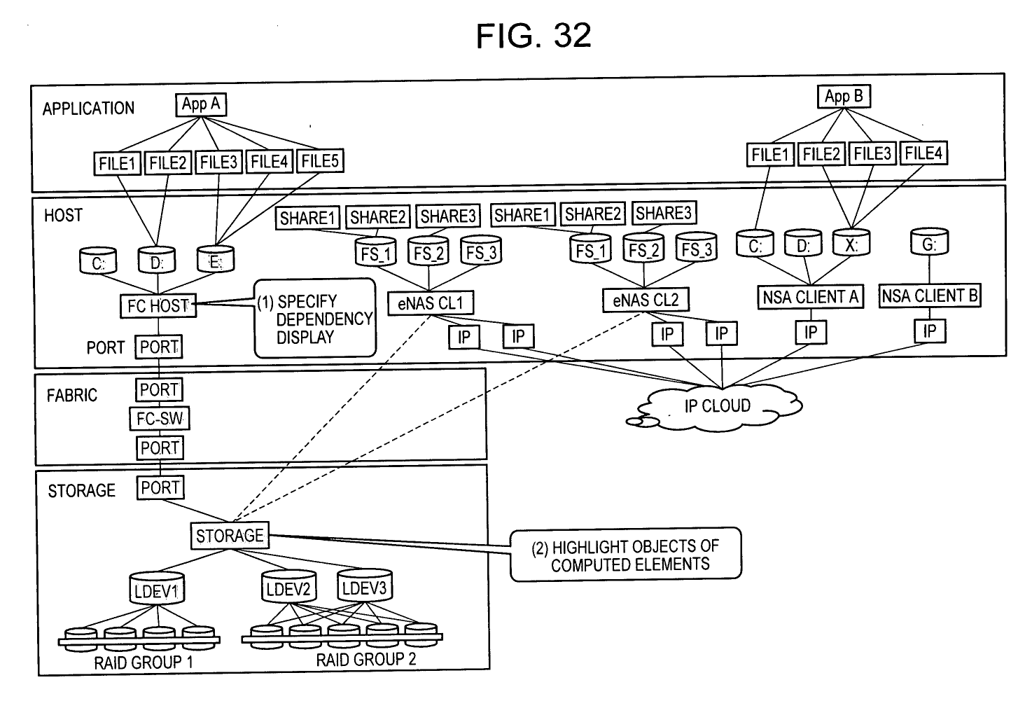

FIG. 32 shows an example of a display of the results of a dependency computation for the FC host “FC host”.

Receiving a specification for the FC host “FC host” and carrying out a prescribed operation in the GUI shown in FIG. 20 results in the reception of a dependency computation command for the element of this object. For example, when “dependency display” is selected from a menu displayed by right clicking the mouse, the dependency computation part 301 computes dependency, and the display control part 305 displays the computation results.

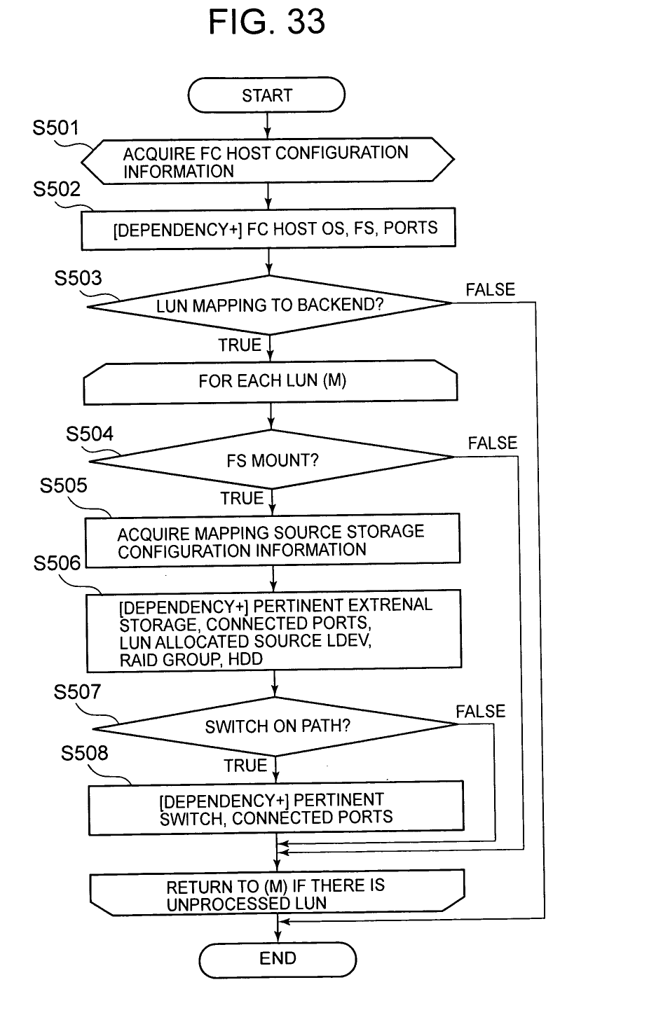

FIG. 33 shows an example of the flow of dependency computation processing for computing an element that is dependent on a specified FC host.

The dependency computation part 301 analyzes the configuration information acquired from an FC host, which has been specified (the specified FC host) (S501), and determines the OS, file system and I/F (port) of this FC host to be dependent elements (S502).

Further, if the results of the analysis of S501 indicate that LUN are mapped to this FC host (S503: TRUE), the dependency computation part 301 carries out S504 through S508 for the respective LUNS. That is, if LUN are mounted to a file system (S504: TRUE), the dependency computation part 301 analyzes the configuration information of the storage subsystem possessing these LUN (S505), and determines the connection-destination ports of this storage subsystem and the FC host in this storage subsystem, and the LDEV, RAID group and disks, which provide the LU of the mapped LUN, to be dependent elements (S506).

Further, if there is a switch between the above-mentioned connection-destination ports of the FC host and storage subsystem, the dependency computation part 301 determines this switch, and this switch's port, which are connected to this FC host and storage subsystem, to be dependent elements (S508).

In accordance with the above series of processes, the elements that are dependent on the specified FC host are determined.

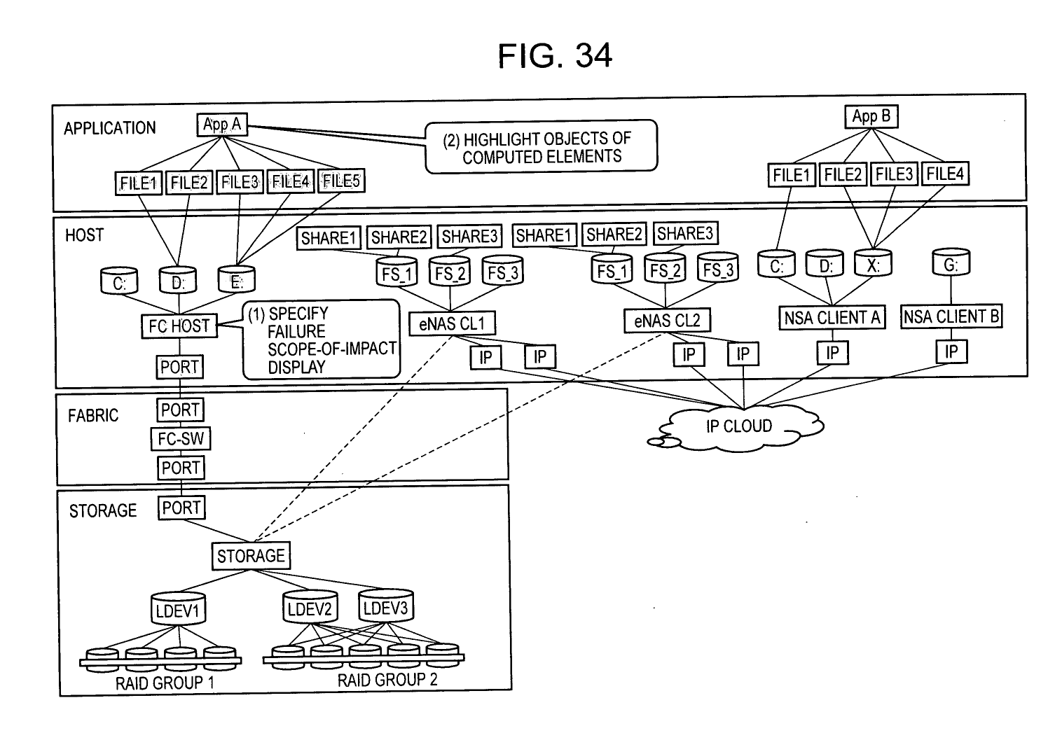

FIG. 34 shows an example of a display of failure impact estimation results for the FC host “FC host”.

Performing a prescribed operation for the user-intended element “FC host” results in the reception of a failure impact estimation command for this element, and in this case, the failure scope-of-impact estimation part 303 estimates the scope of impact of a failure, and the display control part 305 displays the results of the estimation.

FIG. 35 shows one example of the flow of failure scope-of-impact estimation processing for a specified FC host.

The failure scope-of-impact estimation part 303 analyzes configuration information acquired from the specified FC host (S521). If there is a LU mapped to this specified FC host (S522: TRUE), and there is a switch on the path between this LU and the FC host (S523: TRUE), the failure scope-of-impact estimation part 303 treats this switch as a dependent element, and sets the degree of impact to “low” (S524). Further, if there is an application program that uses a file system of the specified FC host (S525: TRUE), the failure scope-of-impact estimation part 303 treats this application program as a dependent element, and sets the degree of impact to “high” (S526).

The preceding is an explanation of examples of dependency computations and failure scope-of-impact estimations.

Furthermore, the above-described technology can also be applied when a storage subsystem is provided with functionality such that a single storage subsystem is virtually a plurality of storage subsystems (hereinafter, the logical partition function).

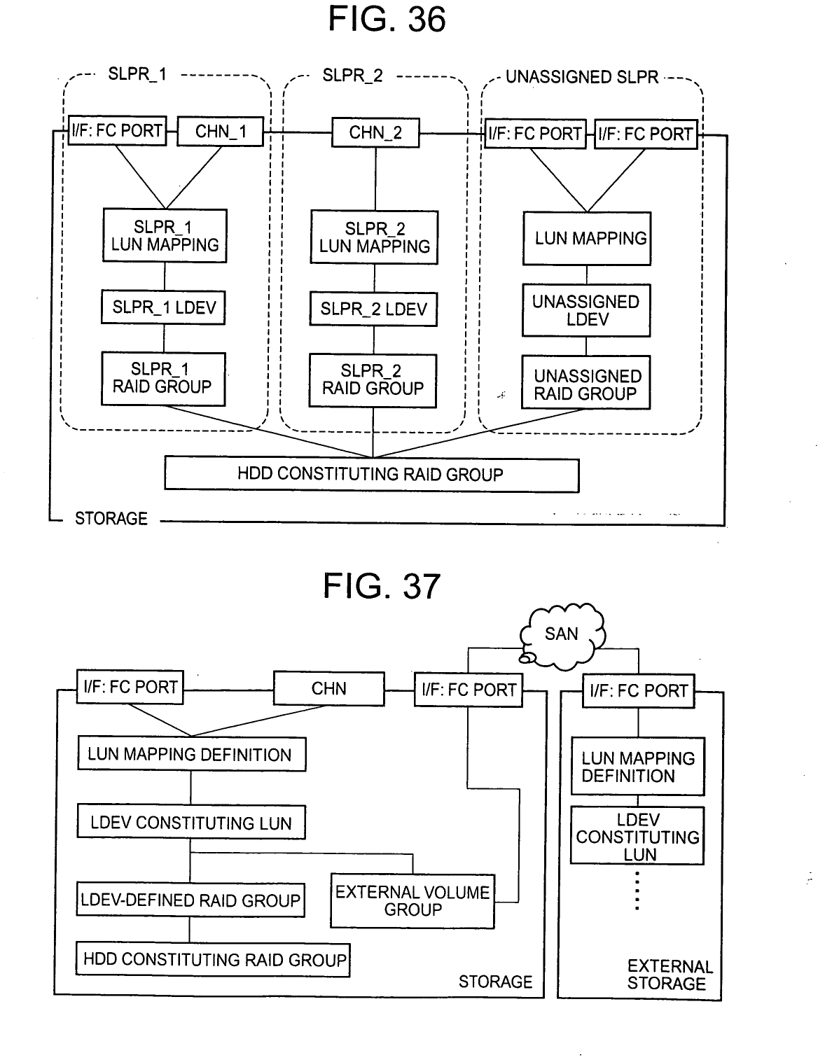

FIG. 36 is a schematic diagram of a logical partition function.

A plurality of logical partitions (indicated in the figure as “SLPR”) is constructed in a storage subsystem, and a port (at least one of a FC port or CHN), LUN, LDEV and RAID group are allocated to the respective logical partitions. An external device (for example, a NAS client, G-NAS, FC host) that is incapable of accessing these logical partitions cannot access elements that belong to these logical partitions. Also, disks do not have to be allocated to a logical partition.

One possible method for managing a logical partition, for example, is to record a logical partition ID, port ID, LUN, LDEV-ID, and RAID group ID for each logical partition in the configuration information managed by a storage subsystem.

Furthermore, an attribute (hereinafter, partition attribute) can be set for each logical partition. An example of a partition attribute can be set for SAN use and NAS use. One possible setting method, for example, is to provide a partition attribute column for each logical partition and to record SAN or NAS in this column via the SVP 131.

With conventional technology, it is impossible to identify whether a host connected to a storage subsystem is a NAS host or a FC host, and it can only be recognized as one host in a SAN. Thus, it is not possible to detect an error in a configuration that takes into account the difference between a SAN and a NAS.

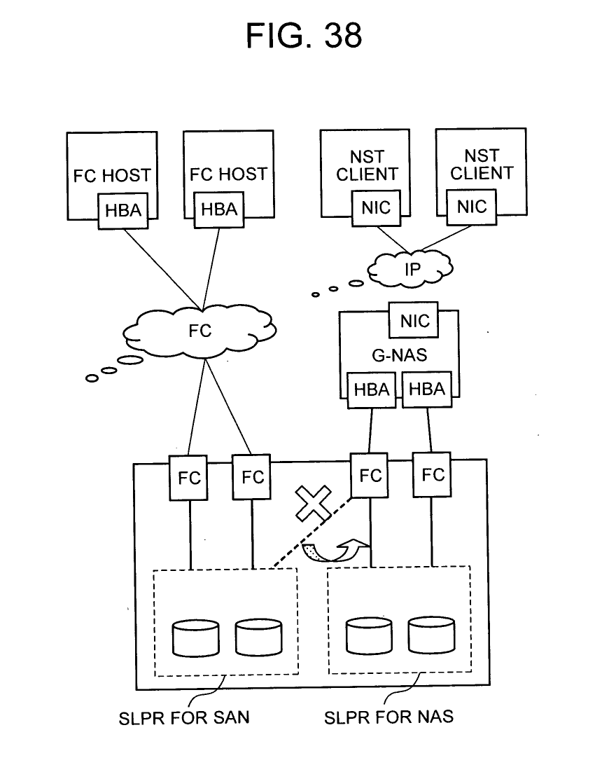

However, in this embodiment, the integrated management software 141 can identify a host connected to a storage subsystem as being either a NAS host or a FC host based on the association results of collected configuration information. For this reason, for example, when a port, to which a NAS host is connected, is allocated to a logical partition for SAN use as illustrated in FIG. 38, because a NAS host will be forced to use a SAN logical partition, the integrated management software 141 can make a determination that this allocation is an incorrect allocation, and can display the results of this determination.

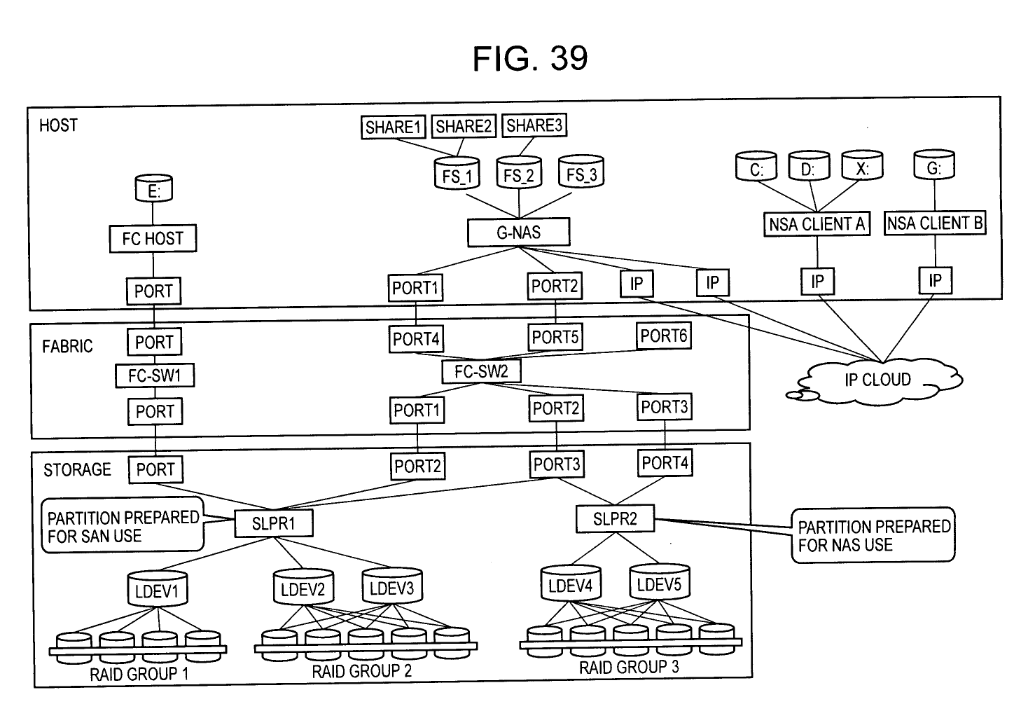

That is, for example, a logical topology like that illustrated in FIG. 39, for example, is displayed by preparing logical partitions 1 and 2, and determining which ports, LDEV and so forth have been allocated to each logical partition. This logical topology is computed by the topology computation part 300. The partition attributes of these logical partitions (for example, SAN, NAS) can be displayed near the objects of the respective logical partitions in the logical topology GUI. Further, in FIG. 39 onward, balloons are shown in the figures for explanation purposes. Although these balloons are not actually displayed in a topology, they could be.

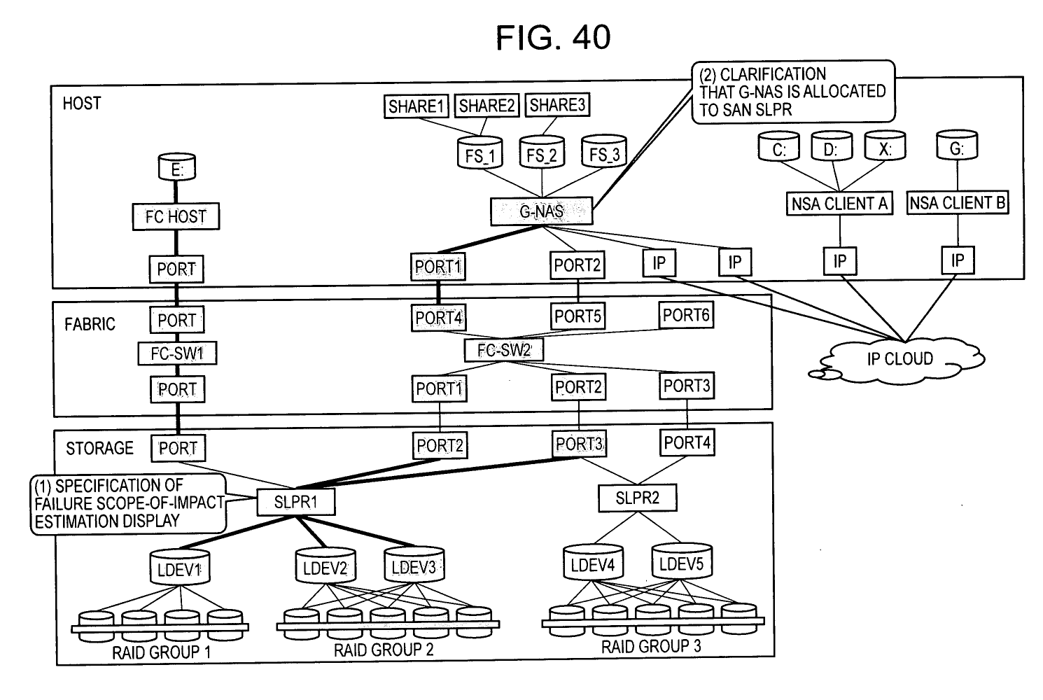

In this case, for example, when a failure scope-of-impact display is specified for the logical partition 1 object “SLPR1” as shown in FIG. 40, the failure scope-of-impact estimation part 303 estimates the scope of impact of a failure using the logical partition 1 as its reference point. More specifically, for example, it specifies elements associated to the logical partition 1 by analyzing mutually associated configuration information, and treats the specified elements as elements that will fall within the scope of impact of a failure. Further, the failure scope-of-impact estimation part 303, in accordance with predetermined conventions, allocates degrees of impact to the elements that fall within the scope of impact of a failure. As the results of this failure scope-of-impact estimation, for example, the display control part 305 highlights the objects of elements that fall within the scope of impact of a failure, as well as the objects (for example, lines) connecting the respective elements as illustrated in FIG. 40. In accordance with this GUI, it is clear that a G-NAS is associated to a logical partition 1 for SAN use. Furthermore, the display control part 305 can highlight the G-NAS object using a different highlight mode than that of the other objects. This makes it easier for the administrator to notice an incorrect configuration. Furthermore, the fact that the allocation of the G-NAS to the logical partition 1 is an incorrect configuration, for example, can be specified when the failure scope-of-impact estimation part 303 detects that the G-NAS has been allocated to logical partition 1, for which the partition attribute is SAN, when estimating the scope of impact of a failure. The display control part 305 can display this result.

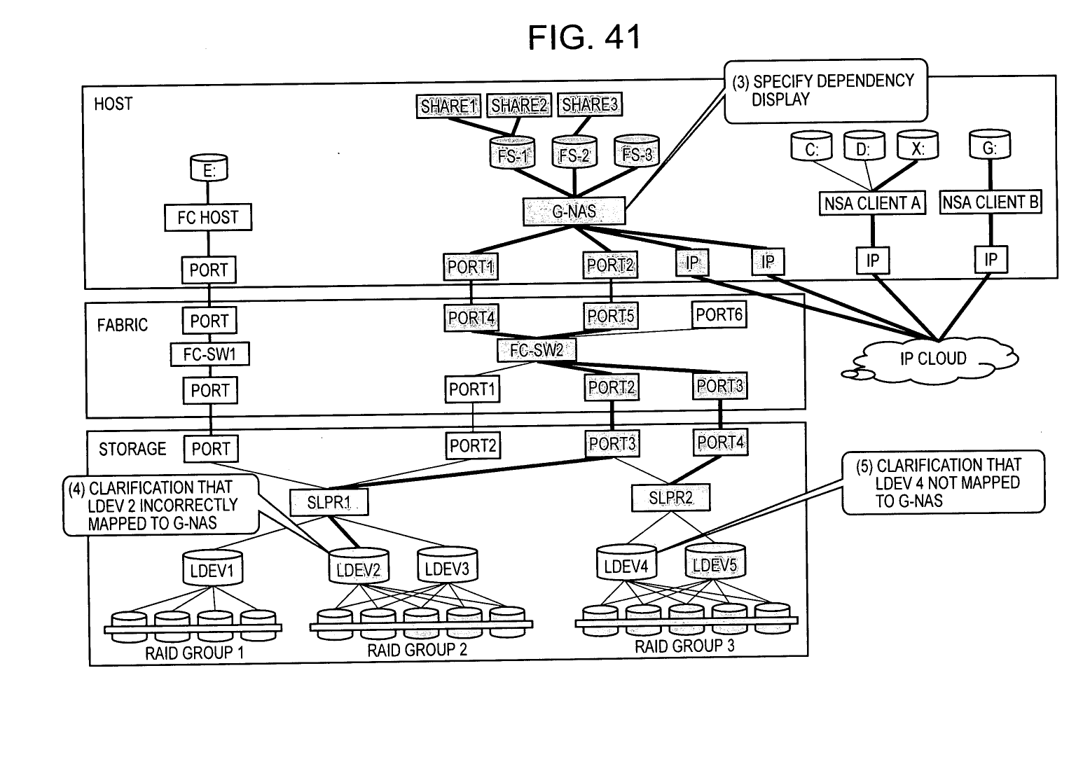

When a dependency display is specified for the G-NAS in the GUI shown in FIG. 40 as illustrated in FIG. 41, the dependency computation part 301 computes the elements that are dependent on the G-NAS, and the display control part 305 highlights the objects of the elements deemed to be dependent, and the objects between these elements as shown in FIG. 41. In accordance with this GUI, it is clear that LDEV 2 has been mistakenly allocated to the G-NAS. Further, it is also clear that LDEV 4, which belongs to the NAS logical partition 2, has not been allocated to the G-NAS.

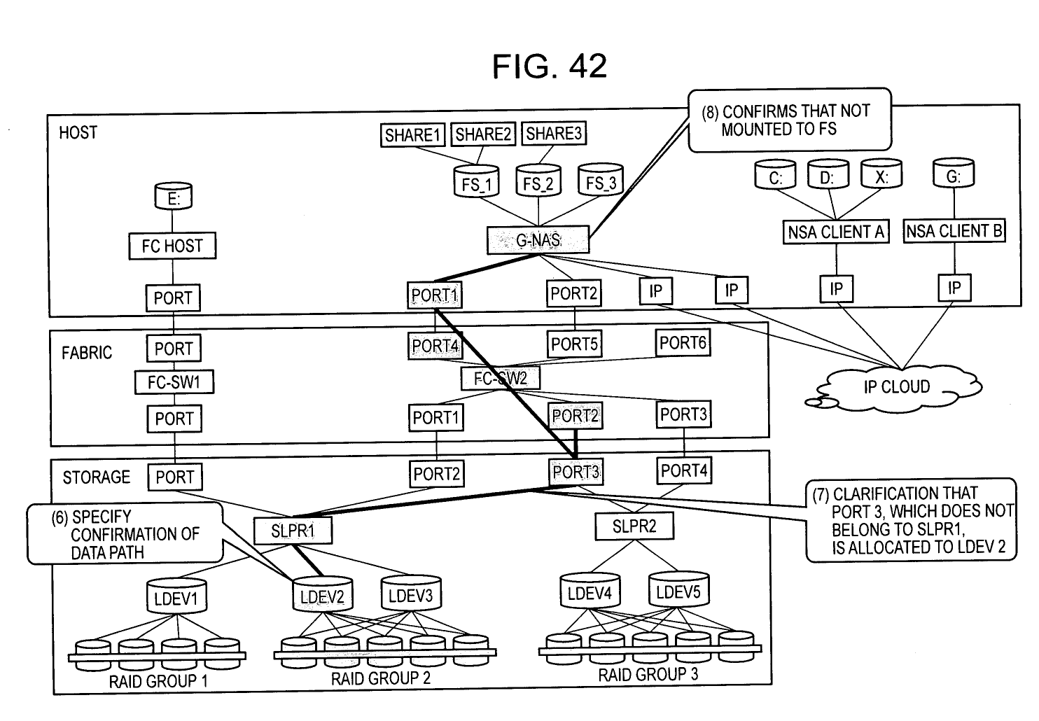

When confirm data path is instructed for the LDEV 2 object in the GUI shown in FIG. 41 as illustrated in FIG. 42 (for example, when this object is specified, and a mouse or other such inputting device is used to select confirm data path from a displayed menu), the data path computation part 307, by analyzing the path setup management table 231 and LUN mapping table 261, for example, can specify the fact that the WWN of the FC port “port 3”, which is allocated to logical partition 2, is allocated to LDEV 2, the WWN of the FC port “port 1” (the port for the G-NAS) of the connection destination of this FC port, and the G-NAS, which has this connection destination FC port. The display control part 305 can highlight the data path, which is constituted by these specified elements. Furthermore, when the data path computation part 307 specifies the fact that an LDEV 2 file system is mounted, the display control part 305 can also highlight the object of this file system. However, in this example, the data path computation part 307 detects that an LDEV 2 file system is not mounted to the G-NAS, and as a result of this, the display control part 305 does not highlight the object of the file system in the G-NAS.

In accordance with the GUI of FIG. 42, it is clear that an LDEV 2 file system is not mounted to the G-NAS. Further, due to the fact that the FC port “port 3”, which is allocated to logical partition 2, is allocated to LDEV 2 of logical partition 1, it is clear that an incorrect data path has been constructed.

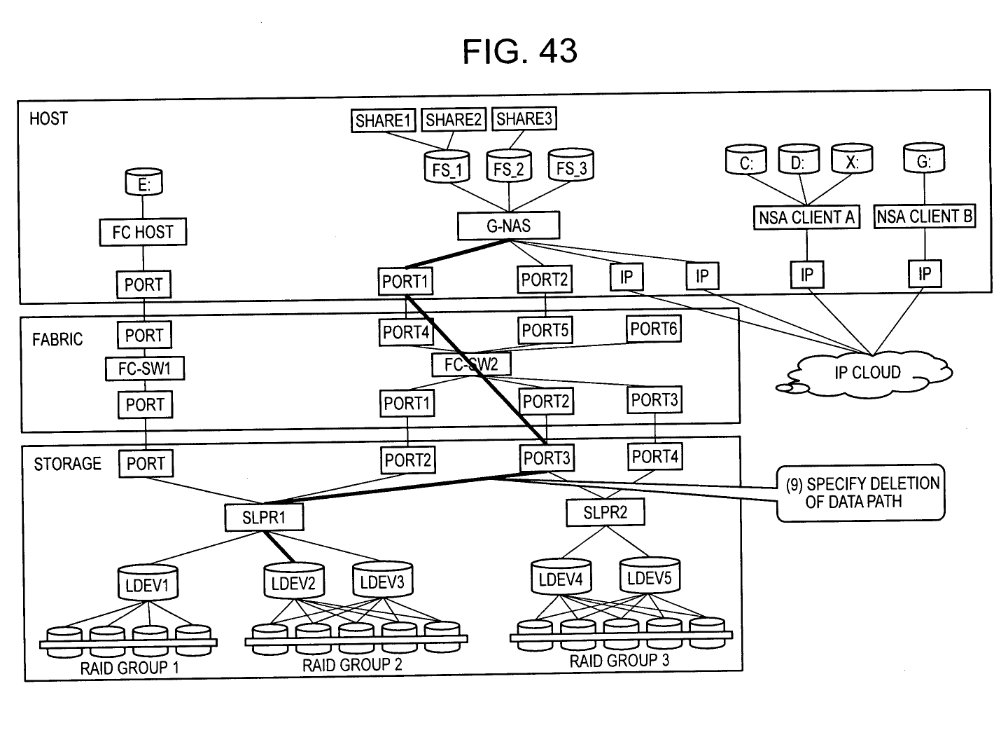

As illustrated in FIG. 43, when an incorrect data path specification is received and a prescribed operation is carried out in the GUI of FIG. 42 (for example, an incorrect data path is specified, and delete data path is selected from a displayed menu), the display control part 305 erases this data path from the GUI, and the configuration modification part 308 carries out configuration modification processing for deleting this data path. More specifically, for example, during this configuration modification process, the configuration modification part 308 specifies a plurality of elements belonging to this data path, and, of the specified plurality of elements, specifies the element interconnections, which constitute this incorrect data path, and instructs devices related to these element interconnections to cancel the specified element interconnections. In this example, for instance, the configuration modification part 308 instructs the storage subsystem, which has logical partitions 1 and 2 to cancel the allocation of port 3, which belongs to logical partition 2, to LDEV 2, which belongs to logical partition 1. This command, for example, is received by SVP 131, and, in response to this command, SVP 131 deletes from the configuration information the association between the WWN of port 3 and LDEV 2. In accordance therewith, the incorrect data path is deleted.

Furthermore, the configuration modification part 308, for example, can also instruct the G-NAS to cancel the allocation of port 3 of the storage subsystem to port 1 of the G-NAS, and, in response to this command, the NAS OS of the G-NAS can cancel the association of port 1 and port 3. A command for the G-NAS can be received by the NAS OS of the G-NAS by way of a prescribed I/F. This I/F can be the management server of the G-NAS (not shown in the figure), or an agent program executed by the G-NAS. This can be assumed to be the same for when some sort of command is sent to the FC host or a NAS client.

Further, if an LDEV 2 file system is mounted to the G-NAS, the configuration modification part 308, for example, can instruct the G-NAS to dismount this file system.

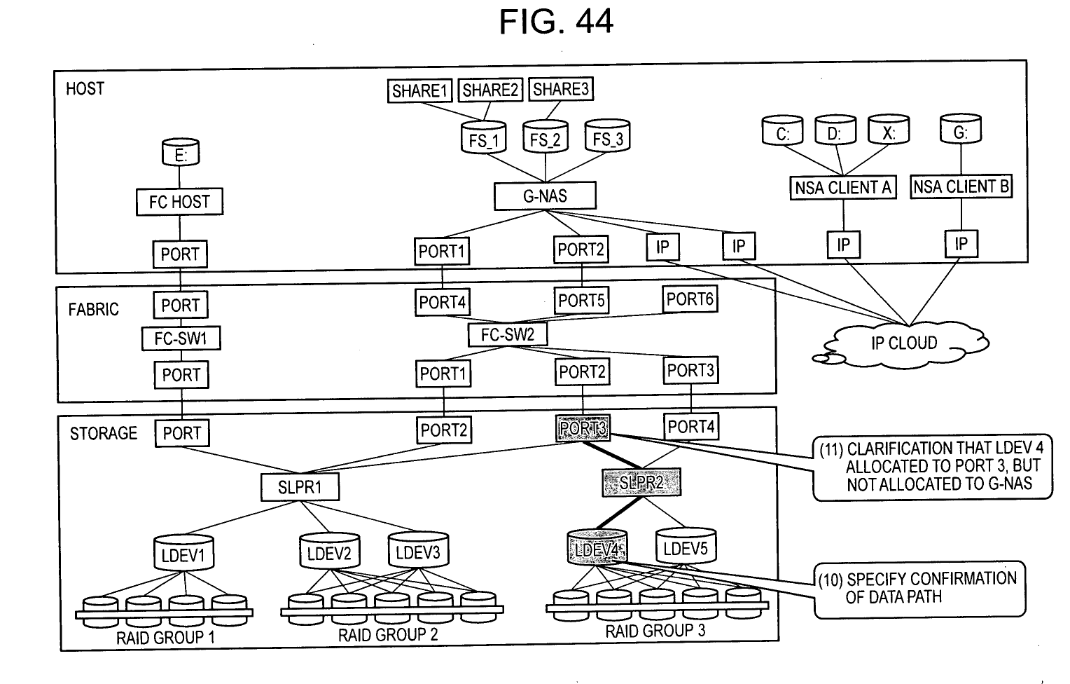

In the GUI of FIG. 41, when a confirm data path is received for LDEV 4 as illustrated in FIG. 44, the data path computation part 307 computes the data path comprising this LDEV 4. The data path computation part 307, for example, by analyzing the path setup table 231 and LUN mapping table 261, can specify that LDEV 4 is allocated to the WWN of the FC port “port 3”, which is allocated to logical partition 2, but it cannot specify the connection destination of this FC port. As a result of this, the display control part 305 highlights the respective objects of LDEV 4, its logical partition 2, and the port 3 specified as being allocated to LDEV 4 as in FIG. 44. The administrator, by looking at this highlighted GUI, can see that LDEV 4 is allocated to port 3, but not allocated to the G-NAS.

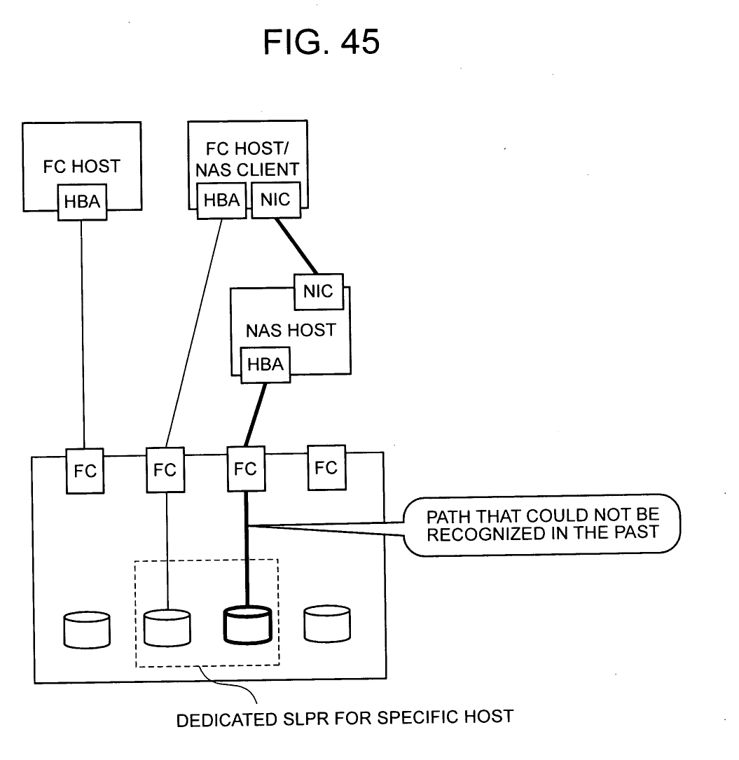

Now then, as illustrated in FIG. 45, it is possible to employ an attribute for special host use as a partition attribute of a logical partition. A special host, for example, can be a FC host/NAS client, which is a computer that serves the role of a NAS client and the role of a FC host. An FC host/NAS client can access an LDEV via an FC port of a storage subsystem as an FC host, and can also access the G-NAS as a NAS client. A G-NAS, which is accessed from a FC host/NAS client can also access an LDEV via an FC port of the storage subsystem. For this reason, a SAN LDEV and a NAS LDEV can co-exist in a logical partition allocated to a FC host/NAS client.

Thus, when a FC host/NAS client uses one logical partition (that is, a single virtual storage system), during a dependency computation or failure scope-of-impact estimation, it is considered necessary to take into account not only the LUN, which are directly mapped via the FC network, but also the LUN utilized by the NAS host. In accordance with the integrated management of the SAN environment and the NAS environment, not only is it possible to ascertain the correctness of a path setup, but it is also possible to more accurately manage the storage capacity (hereinafter, available capacity) utilized by a FC host/NAS client.

More specifically, for example, when a FC host/NAS client uses a first logical volume via the FC, and a second logical volume via the NAS host, the available capacity according to the FC host/NAS client is the total of a first available capacity of the first logical volume and a second available capacity of the second logical volume. In accordance with technology for managing a SAN environment and a NAS environment independently, even if the first available capacity is known, the second available capacity will not be known (the administrator only knows that a second logical volume is allocated to the NAS host, but he does not know that it is allocated to the FC host/NAS client via this NAS host.). However, according to this example, since it is clear which logical volume is being allocated via which NAS host from the FC host/NAS client, it is possible to specify the second available capacity, and, accordingly, the available capacity in accordance with the FC host/NAS client can also be specified.

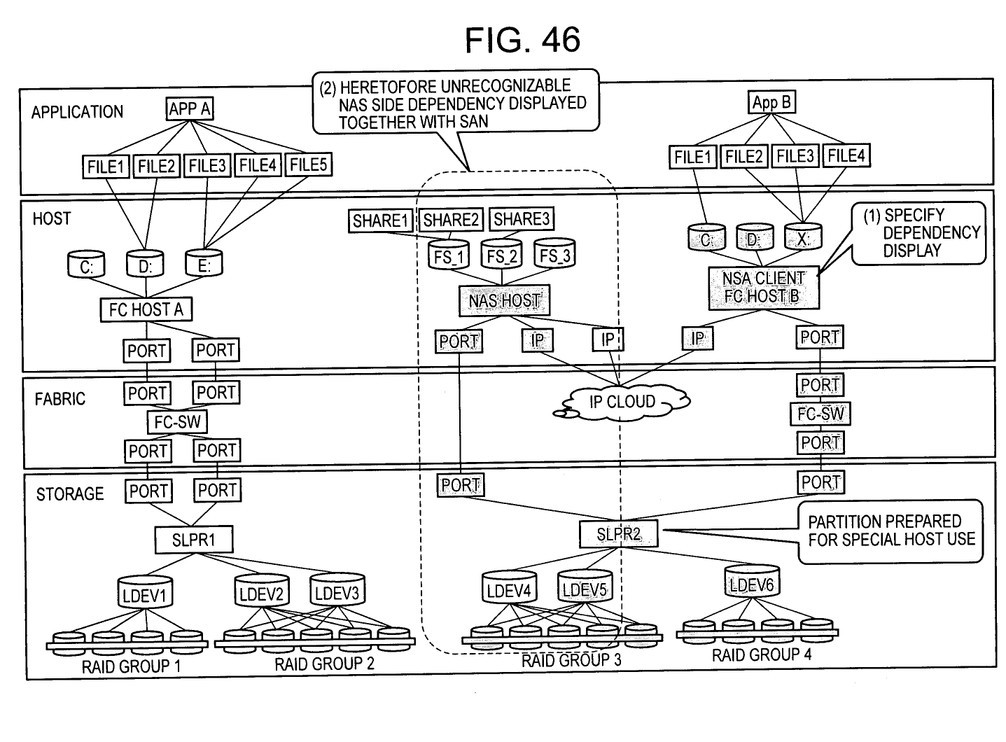

Now then, for example, it is supposed that the logical topology illustrated in FIG. 46 is displayed as the results of a topology computation. In this case, when the dependency computation part 301 receives a dependency display command relative to a FC host/NAS client, it determines an element that is dependent on the FC host/NAS client, and the display control part 305 highlights the object of the determined element. The result of this, as shown in FIG. 46, is that the dependency of the NAS side is displayed together with the dependency of the SAN side.

In accordance with the embodiment described hereinabove, integrated management, which associates a SAN environment to a NAS environment, becomes possible.

Further, in accordance with the above-described embodiment, a topology of a SAN/NAS system is computed, and the results of this topology computation are displayed. Thus, it becomes easier for the administrator to comprehend the configuration of the SAN/NAS system.

In addition, in accordance with the above-described embodiment, there is computed a dependency, which treats a certain element as a reference point, and a failure scope-of-impact, which treats a certain element as a reference point, and the results of these computations are displayed superimposed on a displayed topology. Accordingly, it becomes possible to grasp the scope of impact when a failure occurs, and to quickly and accurately perform maintenance work to clarify the location of the failure.

Further, in accordance with the above-described embodiment, an incorrect configuration can be specified from the respective results of a dependency computation, an estimate of the failure scope-of-impact, and a data path computation, and this incorrect configuration can be deleted.

The preceding has been an explanation of the preferred embodiment of the present invention, but, it goes without saying that the present invention is not limited to this embodiment, and a variety of changes can be made without departing from the gist of the present invention.

For example, another configuration can be employed as the configuration for the storage subsystem 100. More specifically, for example, as the controller part of the storage subsystem 100, CHN, CHA, DKA, SM, CM and SVP were provided, but instead of these, the controller part can be a circuit board comprising a CPU, a memory and a communication port. In this case, the CPU can execute the processing carried out by the plurality of CHA and DKA.

Further, another type of storage device (for example, flash memory) can be mounted to the storage subsystem 100 either instead of or in addition to the disks 135, and the LDEV can be provided by either one or a plurality of other types of storage devices.

Also, for example, in accordance with the administrator instructing the integrated management software 141 to display a failure scope-of-impact, to display dependency, and to confirm a data path, the integrated management software 141, in accordance with these respective commands, is capable of computing and displaying a failure scope-of-impact, computing and displaying dependency, and computing and displaying a data path. Beside this, for example, the integrated management software 141 can also have an incorrect configuration detection part as one of its program modules. An incorrect configuration detection part can detect an incorrect configuration (for example, the allocation of port 3 of a NAS logical partition 2 to LDEV 2, which belongs to a SAN logical partition 1) by executing at appropriate times the failure scope-of-impact estimation part 303, dependency computation part 301, and data path computation part 307 when an incorrect configuration detection event occurs (for example, when an incorrect configuration detection command is received from the administrator). Further, when an incorrect configuration is detected, the incorrect configuration detection part can display this detected configuration on the display control part 305. The incorrect configuration detection part can also instruct the configuration modification part 308 to delete the detected incorrect configuration whether so instructed by the administrator or not.

Further, for example, when SAN and NAS are associated to LUN, and a LUN for SAN use is mapped to the G-NAS, the fact that this is an incorrect mapping can be detected by the integrated management software 141. Further, in addition, the administrator can specify an incorrect mapping while viewing a GUI.

Further, for example, when a determination is made as to a dependent element, the degree of dependency (for example, high, medium or low) related to this element can be allocated on the basis of a prescribed rule. In that case, the display control part 305 may execute highlight display in accordance with the degree of dependency allocated.

What is claimed is:

1. A management computer for managing a computer system comprising one or more SAN devices and one or more NAS devices, wherein
a SAN device is a device connected to a storage area network (SAN), and has a SAN storage resource, which stores SAN configuration information related to elements thereof;
a NAS device is a device connected to an IP network, and has a NAS storage resource, which stores NAS configuration information related to elements thereof;
the one or more SAN devices comprise at least a storage system from among a storage system, which comprises a plurality of storage devices, and a SAN host, which is a host computer that accesses a storage device inside the storage system, and the storage system comprises the SAN storage resource for storing storage configuration information as the SAN configuration information, and a controller part having a plurality of communication ports, and the SAN host comprises the SAN storage resource for storing SAN host configuration information as the SAN configuration information;
the one or more NAS devices comprise a NAS host, which is a NAS head for accessing a storage device inside the storage system, and the NAS host comprises the NAS storage resource for storing NAS host configuration information as the NAS configuration information; and
the controller part of the storage system accesses any of the plurality of storage devices based on the storage configuration information in accordance with an I/O command received from either the NAS host or the SAN host via any of the plurality of communication ports,
the management computer comprising:
a configuration information acquisition part for respectively acquiring the SAN configuration information and the NAS configuration information; and
a configuration association part, which retrieves from the NAS configuration information a second information element that conforms to a first information element in the SAN configuration information, and which associates a retrieved the second information element to the first information element.

2. The management computer according to claim 1, wherein the NAS host is a generic NAS (G-NAS), which is a remote NAS head connected to the storage system via the SAN, and, as an information element in the NAS host configuration information, at least one of a logical unit number (LUN) mapped to the G-NAS, a G-NAS port ID, which is a port ID of a communication port of the G-NAS, and the allocation destination port ID of this communication port exists;
the storage configuration information comprises path information, and the path information is information indicating the respective paths for the storage system, and, as information elements in the path information, a storage port ID, which is a port ID of a communication port of the controller part, the allocation source port ID of this communication port, and a LUN to which the storage device is associated exist;
the first information element is at least one of the storage port ID, the allocation source port ID, and a LUN; and
the second information element is at least one of the G-NAS port ID, the allocation destination port ID and a LUN.

3. The management computer according to claim 2, wherein the configuration association part carries out an association when the storage port ID conforms to the allocation destination port ID, and the allocation source port ID conforms to the G-NAS port ID.

4. The management computer according to claim 1, wherein the NAS host is an embedded NAS (E-NAS), which is the NAS head built into the storage system, and has a storage resource for storing NAS host configuration information as the NAS configuration information, and, as an information element in the NAS host configuration information, at least one of a first type of E-NAS identifier, a logical unit number (LUN) mapped to the E-NAS, and a second type of E-NAS identifier exists;
the controller part comprises the E-NAS;
the storage configuration information comprises at least path information, from among a management identifier for identifying the E-NAS that is used when managing the ENAS and path information, and the path information is information denoting the respective paths in the storage system, and, as information elements in the path information, the port ID of a communication port and a LUN to which the storage device is associated, from which each path is constituted, and an E-NAS identifier as a port ID for each port exist;
the first information element is at least one of the management identifier, the E-NAS identifier as a port ID, and the LUN; and
the second information element is at least one of the first type of E-NAS identifier, the second type of E-NAS identifier, and the LUN.

5. The management computer according to claim 1, further comprising:
a topology computation part for computing the topology of a plurality of elements in the computer system by analyzing the NAS host configuration information and the storage configuration information, which are mutually associated; and
a display control part for displaying the computer topology,
wherein the topology comprises connection relationship of a plurality of elements comprising an element in the NAS host, and a storage device inside the storage system; and
the display control part plots the respective element objects, which are objects denoting the respective elements constituting the computed topology, and the respective element connection objects, which are objects denoting the connections between the respective elements.

6. The management computer according to claim 5, further comprising:
an association computation part for treating an element specified from among a plurality of elements constituting the displayed topology as a reference point, and computing an element, which is related to the specified element,
wherein the display control part makes the display mode of the object of the computed element differ from the display mode of the objects of the other elements constituting the topology.

7. The management computer according to claim 6, wherein the association computation part treats the specified element as a reference point, and computes an element, which impacts on the specified element.

8. The management computer according to claim 6, wherein the association computation part treats the specified element as a reference point, and computes an element, which is impacted by the specified element.

9. The management computer according to claim 6, wherein the association computation part allocates to a computed element, based on a prescribed rule, a degree of association denoting the depth of association to the specified element; and
the display control part sets the display mode of the object of the computed element to a display mode corresponding to the allocated degree of association.

10. The management computer according to claim 5, further comprising:
an association computation part, which receives a designation for a certain data element of a plurality of elements constituting the displayed topology, treats the designated data element as a reference point, and computes a data path comprising the designated data element,
wherein the display control part makes the display mode of the object related to the computed data path differ from the display mode of the other objects constituting the topology; and
the data element is an element related to data, which is exchanged between at the least one of the SAN host and the NAS host, and a storage device inside the storage system, and is at least one of a storage device and a communication port.

11. The management computer according to claim 6, wherein the display control part displays the computed topology as a graphical user interface (GUI), and receives a designation for an element from a user by way of the plotted objects; and
the association computation part treats an element corresponding to an object designated by a user on the GUI as a reference point, and computes an element, which is related to the designated element.

12. The management computer according to claim 1, wherein the NAS device has a NAS client, which transmits an I/O command to the NAS host;
the NAS client has a storage resource for storing NAS client configuration information as the NAS configuration information, and, as an information element in the NAS client configuration information, at least one of an IP address allocated to a communication port of the NAS client, and an ID of a share area which the NAS client uses exists;
as an information element in the NAS host configuration information, at least one of an IP address of a communication port of the NAS client, and an ID of a share area which the NAS host uses exists;
the configuration association part retrieves from the NAS host configuration information a fourth information element conforming to a third information element in the NAS client configuration information, and associates the third information element in the NAS client configuration information to the retrieved fourth information element; and
the third and fourth information elements are at least one of a share area ID and an IP address.

13. The management computer according to claim 1, wherein, in the storage configuration information, an attribute for either a SAN element or a NAS element is made correspondent to a prescribed type of element of a plurality of elements being managed via the storage configuration information,
the management computer comprising:
a configuration correctness determination part for determining the presence of an incorrect association by analyzing the NAS host configuration information and the storage configuration information, which are mutually associated in accordance with association of the first and second information elements; and
a display control part for displaying results of a determination by the configuration correctness determination part,
and wherein the incorrect association is the association of the NAS host to the SAN element.

14. The management computer according to claim 13, wherein the result of a determination displayed by the display control part is a GUI,
the management computer further comprising:
a configuration modification part for receiving from a user via the GUI a command to cancel an incorrect association, and upon receiving the command, transmitting to a device, of the SAN device and the NAS device, which has the configuration information for managing the element related to the incorrect association, a command instructing the cancellation of an element related to the incorrect association.

15. The management computer according to claim 1, wherein the storage system comprises a plurality of virtual storage systems, and each element that exists in the storage system is allocated to an ID of the respective virtual storage systems in the storage configuration information, and
the management computer further comprises:
a topology computation part for computing the topology of a plurality of elements in the computer system by analyzing the SAN configuration information and the NAS configuration information, which are mutually associated; and
a display control part for displaying the computed topology,
and wherein the display control part plots the respective element objects, which are objects denoting the respective elements constituting the computed topology, and the respective element connection objects, which are objects denoting the connections between the respective elements; and
the virtual storage system is included in the element objects.

16. The management computer according to claim 15, wherein the displayed topology is a GUI,
the management computer further comprising:
a first association computation part, which, of the plurality of elements constituting the displayed topology, treats the virtual storage system designated via the GUI as a reference point, and computes an element which is impacted by the designated virtual storage system;
a second association computation part, which treats either the SAN host or the NAS host, which has been designated from among the one or more elements computed by the first association computation part, as a reference point, and computes an element, which impacts on the designated either SAN host or NAS host; and
a third association computation part, which, of the one or more elements computed by the second association computation part, treats a designated data element as a reference point, and computes a data path comprising the designated data element,
wherein the display control part makes the display mode of the object related to the computed data path differ from the display mode of the other objects constituting the topology; and
the data element is an element related to data exchanged between at least one of the SAN host and the NAS host, and a storage device inside the storage system, and is at least one of either a storage device or a communication port.

17. The management computer according to claim 16, further comprising:
a configuration modification part for receiving from the user via the GUI a command to cancel a data path designated by the user, and upon receiving the command, transmitting to a device, of the SAN device and the NAS device, which has the configuration information for managing the element related to the designated data path, a command instructing the cancellation of an element related to the designated data path.

18. The management computer according to claim 1, wherein the configuration association part retrieves from the storage configuration information a sixth information element, which conforms to a fifth information element in the SAN host configuration information, and associates the retrieved the sixth information element to the fifth information element, and
the management computer further comprises:
a topology computation part for computing the topology of a plurality of elements in the computer system by analyzing the SAN configuration information, the NAS configuration information, and the storage configuration information, which are mutually associated;
a display control part for displaying a GUI of the computed topology;
a first association computation part, which, of the plurality of elements constituting the displayed topology, treats the element designated via the GUI as a reference point, and computes an element which impacts the designated element; and
a second association computation part, which, of the plurality of elements constituting the displayed topology, treats the element designated via the GUI as a reference point, and computes an element which is impacted by the designated element,
wherein the topology comprises a first connection relationship of a plurality of elements comprising an element in the SAN host, and a storage device inside the storage system, and a second connection relationship of a plurality of elements comprising an element in the NAS host, and a storage device inside the storage system; and
the display control part plots the respective element objects, which are objects denoting the respective elements constituting the computed topology, and the respective element connection objects, which are objects denoting connections between the respective elements, and makes the display mode of the objects of the elements computed by the first and second association computation parts differ from the display mode of the objects of the other elements constituting the topology.

19. A method for managing a computer system comprising one or more SAN devices and one or more NAS devices,
wherein a SAN device is a device connected to a storage area network, and has a SAN storage resource, which stores SAN configuration information related to elements thereof;
a NAS device is a device connected to an IP network, and has a NAS storage resource, which stores NAS configuration information related to elements thereof;
the one or more SAN devices comprise at least a storage system from among a storage system, which comprises a plurality of storage devices, and a SAN host, which is a host computer that accesses a storage device inside the storage system, and the storage system comprises the SAN storage resource for storing storage configuration information as the SAN configuration information, and a controller part having a plurality of communication ports, and the SAN host comprises the SAN storage resource for storing SAN host configuration information as the SAN configuration information;
the one or more NAS devices comprise a NAS host, which is a NAS head for accessing a storage device inside the storage system, and the NAS host comprises the NAS storage resource for storing NAS host configuration information as the NAS configuration information, and wherein
the management method comprises the steps of:
respectively acquiring the SAN configuration information and the NAS configuration information; and
retrieving from the NAS configuration information a second information element that conforms to a first information element in the SAN configuration information, and associating the retrieved second information element to the first information element.

20. A computer program for constructing a computer for managing a computer system comprising one or more SAN devices and one or more NAS devices,
wherein a SAN device is a device connected to a storage area network, and has a SAN storage resource, which stores SAN configuration information related to elements thereof;
a NAS device is a device connected to an IP network, and has a NAS storage resource, which stores NAS configuration information related to elements thereof;
the one or more SAN devices comprise at least a storage system from among a storage system, which comprises a plurality of storage devices, and a SAN host, which is a host computer that accesses a storage device inside the storage system, and the storage system comprises the SAN storage resource for storing storage configuration information as the SAN configuration information and a controller part having a plurality of communication ports, and the SAN host comprises the SAN storage resource for storing SAN host configuration information as the SAN configuration information;
the one or more NAS devices comprise a NAS host, which is a NAS head for accessing a storage device inside the storage system, and the NAS host comprises the NAS storage resource for storing NAS host configuration information as the NAS configuration information, and wherein
the computer program executes on the computer the steps of:
respectively acquiring the SAN configuration information and the NAS configuration information; and
retrieving from the NAS configuration information a second information element that conforms to a first information element in the SAN configuration information, and associating the retrieved second information element to the first information element.
